(19) United States
(12) Patent Application Publication
(10) Pub. No.: US 2006/0195308 A1
(43) Pub. Date: Aug. 31, 2006

(54) Methods and models for cholesterol metabolism

(75) Inventors: Ananth Kadambi, Daly City, CA (US); Ganesh Balgi, Cupertino, CA (US); Thomas Paterson, Redondo Beach, CA (US)

Correspondence Address: ENTELOS, INC.;c/o FOLEY & LARDNER LLP, 1530 PAGE MILL RD., PALO ALTO, CA, 94304, US

(73) Assignee: Entelos, Inc.

(21) Appl. No.: 11/305,317

(22) Filed: Dec. 16, 2005

Related U.S. Application Data
(60) Provisional application No. 60/637,106, filed on Dec. 16, 2004.

(51) Int. Cl. G06G 7/48; G06G 7/58

(52) U.S. Cl. 703/11

(57) ABSTRACT

The invention encompasses novel methods for developing a computer model of cholesterol metabolism in an animal. In particular, the models include representations of biological processes associated with both lipid flux and lipoprotein particles. The invention also encompasses computer models of cholesterol metabolism, methods of simulating cholesterol metabolism and computer systems for simulating cholesterol metabolism.

### A. CROSS-REFERENCE TO RELATED APPLICATION

This application claims the benefit of U.S. Provisional Application No. 60/637,106, filed Dec. 16, 2004.

### I. INTRODUCTION

1. Field

The present disclosure relates to mathematical and computer models of cholesterol metabolism.

2. Background

Modeling of cholesterol metabolism has focused on two methods to quantify the dynamics of the particle and lipid molecule domains. One of the methods models the lipoprotein particle domain, employing apoB-100 particle tracer studies to define the synthesis, turnover, and catabolism of VLDL, IDL, and LDL particle classes (Prinsen et al., J. Lipid Res., 44:1341-48, 2003; Demant et al., J. Clin. Invest., 88: 1490-1501, 1991; Packard et al., J. Lipid Res. 41:305-8, 2000). The other method models the lipid molecule domain, employing labeled cholesteryl ester and triglyceride molecules to determine lipid flow between the tissue and vascular compartments (Schwartz et al., J. Lipid Res., 45: 1594-1607, 2004; Grundy and Ahrens, J. Lipid Res., 10: 91-107, 1969). Because these models investigate each domain separately, neither accurately captures the interaction between the lipoprotein particles, lipid molecules, vascular compartment, hepatic, and peripheral tissues.

Provided herein are predictive computer models of cholesterol transport that integrate publicly available data on lipoprotein particle composition and number for VLDL, IDL, LDL, and HDL particles, lipoprotein and tissue-associated enzyme and receptor activity, and hepatic lipoprotein particle synthesis to generate virtual profiles of blood cholesterol in an animal. The models are fully responsive to dietary and pharmacological perturbations that affect cholesterol synthesis and excretion as well as enzymatic activity and tissue receptor expression.

### SUMMARY OF THE INVENTION

One aspect of the invention provides methods for developing a computer model of cholesterol metabolism in an animal, said method comprising identifying one or more biological processes associated with lipoprotein particles; identifying one or more biological processes associated with lipid flux; mathematically representing each biological process to generate one or more representations of a biological process associated with lipoprotein particles and one or more representations of a biological process associated with lipid flux; and combining the representations of biological process to form a computer model of the cholesterol metabolism.

A biological processes associated with lipid flux can be associated with, inter alia, lipid flux from liver tissue to a lipoprotein particle, lipid flux from a lipoprotein particle to liver tissue, lipid flux from one lipoprotein particle to another lipoprotein particle of the same or different class or subclass, lipid flux from peripheral tissue to a lipoprotein particle, or lipid flux from a lipoprotein particle to a peripheral tissue. In certain implementations of the invention, the mathematical representation of a biological process associated with lipid flux includes a variable representing total cholesterol, total triglyceride, a cholesterol ester (CE) per particle class and/or subclass, a triglyceride (TG) content per particle class and/or subclass, a hepatic enzyme, a peripheral enzyme, a hepatic receptor, a peripheral receptor, or a therapeutic agent.

A biological processes associated with lipoprotein particles can be a biological process associated with synthesis, reclassification or catabolism of lipoprotein particles. One or more biological processes can be associated with lipoprotein particle secretion form a hepatic compartment. In a preferred implementation of the invention, the mathematical representation of a biological process associated with lipoprotein particles includes a variable representing a class of lipoprotein particles, a subclass of lipoprotein particles, a number of lipoprotein particles, an apolipoprotein composition of a lipoprotein particle, a cholesteryl ester (CE) content of a lipoprotein particle, a triglyceride (TG) content of a lipoprotein particle, a free cholesterol (FC) content of a lipoprotein particle, a hepatic enzyme, a hepatic receptor, or a therapeutic agent.

In certain implementations, the method of developing a model of cholesterol metabolism includes mathematically representing a biological processes comprises forming a first mathematical relation among variables associated with a first biological process from one or more of the biological processes associated with lipoprotein particles and/or lipid flux; and forming a second mathematical relation among variables associated with the first biological process and a second biological process from one or more of the biological processes associated with lipoprotein particles and/or lipid flux. The method can further comprise creating a set of parametric changes in the first mathematical relation and the second mathematical relation; and producing a simulated biological attribute based on at least one parametric change from the set of parametric changes, the simulated biological attribute being substantially consistent with at least one biological attribute associated with a reference pattern of a first cholesterol metabolic steady state. The method can even further include converting a parameter into a converted biological variable, the value of which changes upon perturbation of cholesterol homeostasis in an animal, the parameter being associated with at least one from the first mathematical relation and the second mathematical relation; and, producing a series of simulated biological attributes based on the converted biological variable, the series of simulated biological attributes being substantially consistent with a corresponding biological attribute associated with a reference pattern of an animal, the series of simulated biological attributes representing a second cholesterol metabolic steady state.

Another aspect of the invention provides computer-readable media having computer-readable instructions stored thereon that, upon execution by a processor, cause the processor to simulate cholesterol metabolism in an animal, and further wherein the instructions comprise a) defining a mathematical representation of one or more biological processes associated with lipoprotein particles; b) defining a mathematical representation of one or more biological processes associated with lipid flux; and c) defining a set of mathematical relationships between the representations of biological processes to form a model of cholesterol metabolism. In a preferred implementation, the instructions further comprise accepting user input specifying one or more parameters or associated with one or more of the mathematical representations. Alternatively, or in addition, the instructions can include applying a virtual protocol to the model of cholesterol metabolism. Preferably, the virtual protocol represents a therapeutic regimen, a diagnostic procedure, passage of time, or an altered diet. The instructions, optionally, may comprise defining one or more virtual patients.

Yet another aspect of the invention provides, methods of simulating cholesterol metabolism in an animal, said method comprising executing the computer model described above. Because they include lipid and particle dynamics, rather than only particle dynamics or only lipid dynamics, the models of the invention are capable of modeling chronic therapy responses and maintaining mass balance of the lipids. Preferably, the method includes applying a virtual protocol to the computer model to generate a set of outputs representing a phenotype of a biological system. The virtual protocol can represent, inter alia, a therapeutic regimen, a diagnostic procedure, passage of time, or an altered diet. In certain implementations, the set of outputs represents a diseased state, e.g. dislipidemia. The method of simulating cholesterol metabolism can also comprise accepting user input specifying one or more parameters or variable associated with one or more mathematical representations prior to executing the computer model.

One aspect of the invention provides a system comprising a) a processor including computer-readable instructions stored thereon that, upon execution by a processor, cause the processor to simulate cholesterol metabolism in an animal; b) a first user terminal, the first user terminal operable to receive a user input specifying one or more parameters associated with one or more mathematical representations defined by the computer readable instructions; and c) a second user terminal, the second user terminal operable to provide the set of outputs to a second user. The computer readable instructions preferably include i) mathematically representing one or more biological processes associated with lipoprotein particles; ii) mathematically representing one or more biological processes associated with lipid flux; and iii) defining a set of mathematical relationships between the representations of biological processes associated with lipoprotein particles and representations of biological processes associated lipid flux; and iv) applying a virtual protocol to the set of mathematical relationships to generate a set of outputs.

It will be appreciated by one of skill in the art that the embodiments summarized above may be used together in any suitable combination to generate additional embodiments not expressly recited above, and that such embodiments are considered to be part of the present invention.

### II. BRIEF DESCRIPTION OF THE DRAWINGS

The skilled artisan will understand that the drawings, described below, are for illustration purposes only. The drawings are not intended to limit the scope of the present teaching in any way.

FIG. 1A provides a flowchart depicting an exemplary embodiment of a method for developing a computer model of cholesterol metabolism in an animal.

FIG. 1B illustrates an exemplary method of partitioning particles to a certain class or subclass based on total lipid content.

FIG. 1C illustrates a exemplary set of biological components taken into consideration in developing a model of cholesterol metabolism at homeostasis.

FIG. 1D illustrates the behavior of a single subclass of lipoprotein particles within one implementation of the invention.

FIG. 2 illustrates an exemplary embodiment of an Effect Diagram depicting apoB-100 and HDL particle composition monitors.

FIG. 3 illustrates an exemplary embodiment of a Summary Diagram that links modules for the lipoprotein particle domain and the lipid molecule domain.

FIG. 4 illustrates an exemplary embodiment of a lipoprotein particle module diagram for the ApoB-100 particle module depicted in FIG. 3. In particular, FIG. 4 illustrates an exemplary embodiment of an Effect Diagram depicting the synthesis, reclassification and catabolism of ApoB-100.

FIGS. 5A-5C illustrate exemplary embodiments of module diagrams for the VLDL1, VLDL2, IDL, LDL-L and LDL-S particles depicted in FIG. 4. FIG. 5A provides an Effect Diagram depicting VLDL1 and VLDL2 particle remodeling. FIG. 5B provides an Effect Diagram depicting IDL particle remodeling. FIG. 5C provides an Effect Diagram depicting LDL-L and LDL-S particle remodeling.

FIGS. 6A-6B illustrate exemplary embodiments of lipid molecule domains in hepatic tissue and peripheral tissue depicted in FIG. 3. FIG. 6A provides an Effect Diagram depicting hepatic lipid stores. FIG. 6B provides an Effect Diagram depicting peripheral lipid stores.

FIG. 7 illustrates an exemplary embodiment of a module depicting cholesteryl ester and triglyceride flux between the lipoprotein particle domain and the lipid molecule domain depicted in FIG. 2. FIG. 7 provides an Effect Diagram depicting the effects of ApoB-100 and HDL particle synthesis and catabolism on cholesterol ester and triglycerides stores.

FIGS. 8A-8C illustrate exemplary embodiments of modules depicting the affect of enzymatic activity on the composition and number of ApoB-100 lipoprotein particles depicted in FIG. 3. FIG. 8A provides an Effect Diagram depicting the net enzyme activity of VLDL1 and VLDL2 particles. FIG. 8B provides an Effect Diagram depicting the net enzyme activity of IDL particles. FIG. 8C provides an Effect Diagram depicting the net enzyme activity of LDL-L and LDL-S particles.

FIGS. 9A-9D illustrate exemplary embodiments of modules depicting the affect of hepatic and peripheral enzymes and receptors on the delipidation of ApoB-100 particles and HDL particles depicted in FIG. 3. FIG. 9A provides an Effect Diagram depicting the effect of certain hepatic and peripheral enzymes and receptors on delipidation of ApoB-100 and HDL particles. FIG. 9B provides an Effect Diagram the activity of hepatic lipase (HL) and lipoprotein lipase (LPL) and their effect on lipid flux. FIG. 9C provides an Effect Diagram the activity of scavenger receptor class B type I (SRB1 or SR-B1) and its effect on lipid flux. FIG. 9D provides an Effect Diagram depicting the effect of low density lipoprotein receptor (LDLr) activity.

FIGS. 10A-10D illustrate exemplary embodiments of modules depicting biological processes affecting HDL particle synthesis, reclassification and catabolism. FIG. 10A provides an Effect Diagram depicting synthesis, reclassification and catabolism of HDL particles in general. FIG. 10B provides an Effect Diagram depicting HDL particle remodeling. FIG. 10C provides an Effect Diagram depicting net enzyme activity, particularly of HL and CETP in HDL1 particles. FIG. 10D provides an Effect Diagram depicting net enzyme activity, particularly of LCAT, HL and CETP in HDL2 and HDL3 particles.

FIGS. 11A-11B illustrate exemplary embodiments of modules depicting cholesterol ester transfer protein activity the lipid composition of HDL and apoB-100 particles. FIG. 11A provides an Effect Diagram depicting CETP activity in HDL1 particles. FIG. 11B provides and Effect Diagram depicting CETP activity in HDL2 particles.

FIG. 12 illustrates an exemplary embodiment of modules depicting additional biological processes that can affect the synthesis, catabolism, and lipid composition of ApoB-100 particles and HDL particles.

FIG. 13 illustrates an exemplary embodiment of a module depicting dietary cholesterol transport.

FIG. 14 illustrates an exemplary embodiment of a module depicting various clinical measures used to provide data for the biological processes depicted in the modules.

FIGS. 15A-15H illustrate different configurations of vector diagrams of net TG and CE fluxes.

FIG. 16A illustrates the ApoB-100 particle composition in a reference virtual patient.

FIG. 16B illustrates the effect of the therapeutic agent, atorvastatin, on the ApoB-100 particle composition in a reference virtual patient.

FIG. 16C illustrates the ApoB-100 particle composition in a Type IIb dyslipidemic virtual patient.

FIG. 16D illustrates the effect of the therapeutic agent, atorvastatin, on the ApoB-100 particle composition in a Type IIb dyslipidemic virtual patient.

FIG. 17A illustrates the HDL particle composition in a reference virtual patient;

FIG. 17B illustrates the effect of the therapeutic agent, atorvastatin, on the HDL particle composition in a reference virtual patient.

FIG. 17C illustrates the HDL particle composition in a Type IIb dyslipidemic virtual patient.

FIG. 17D illustrates the effect of the therapeutic agent, atorvastatin, on the HDL particle composition in a Type IIb dyslipidemic virtual patient.

FIGS. 18A-18B illustrate the effect of the therapeutic agent, atorvastatin, on plasma lipids in a reference virtual patient.

FIGS. 18C-18D illustrate the effect of the therapeutic agent, atorvastatin, on plasma lipids in a Type IIb dyslipidemic virtual patient.

### III. DETAILED DESCRIPTION

A. Overview

The invention encompasses novel methods for developing a computer model of cholesterol metabolism in an animal. In particular, the models include representations of biological processes associated with both lipid flux and lipoprotein particles. The invention also encompasses computer models of cholesterol metabolism, methods of simulating cholesterol metabolism and computer systems for simulating cholesterol metabolism.

B. Definitions

A “biological system” can include, for example, an individual cell, a collection of cells such as a cell culture, an organ, a tissue, a multi-cellular organism such as an individual human patient, a subset of cells of a multi-cellular organism, or a population of multi-cellular organisms such as a group of human patients or the general human population as a whole. A biological system can also include, for example, a multi-tissue system such as the nervous system, immune system, or cardio-vascular system.

The term “biological component” refers to a portion of a biological system. A biological component that is part of a biological system can include, for example, an extra-cellular constituent, a cellular constituent, an intra-cellular constituent, or a combination of them. Examples of suitable biological components, include, but are not limited to, metabolites, DNA, RNA, proteins, surface and intracellular receptors, enzymes, lipid molecules (i.e., free cholesterol, cholesterol ester, triglycerides, and phospholipid), hormones, cells, organs, tissues, portions of cells, tissues, or organs, subcellular organelles, chemically reactive molecules like H⁺, superoxides, ATP, as well as, combinations or aggregate representations of these types of biological components. In addition, biological components can include therapeutic agents such as HMG-CoA reductase inhibitors (e.g., statins), cholesterol absorption inhibitors (e.g., ezetimibe), MTP inhibitors (e.g., garlic), CETP inhibitors (e.g., torcetrapib), as well as combination therapies (e.g., vytorin).

The term “biological process” is used herein to mean an interaction or series of interactions between biological components. Examples of suitable biological processes, include, but are not limited to, lipoprotein particle synthesis, apolipoprotein composition of lipoprotein particles, lipid composition of lipoprotein particles, catabolism of lipoprotein particles, remodeling of lipoprotein particles into different classes and subclasses, storage of lipid molecules in hepatic and peripheral tissues, and transport of lipid molecules between hepatic, vascular and peripheral tissues. The term “biological process” can also include a process comprising one or more therapeutic agents, for example the process of binding a therapeutic agent to a cellular mediator. Each biological variable of the biological process can be influenced, for example, by at least one other biological variable in the biological process by some biological mechanism, which need not be specified or even understood.

The term “parameter” is used herein to mean a value that characterizes the interaction between two or more biological components. Examples of parameters include affinity constants, Kₘ, K_{d}, k_{cat}, net flux of lipid molecules, such as cholesterol ester (CE) and triglycerides (TG), out of each particle class and into hepatic or peripheral stores, rate of cholesterol synthesis, rate of triglyceride synthesis, rate of synthesis of apoB-100 particle classes, and rate of HDL particle formation.

The term “variable,” as used herein refers to a value that characterizes a biological component. Examples of variables include the total number of lipoprotein particles, the number of lipoprotein particles of a particular class or subclass, apolipoprotein composition of a lipoprotein particle, cholesteryl ester (CE) content of a lipoprotein particle, triglyceride (TG) content of a lipoprotein particle, free cholesterol (FC) content of a lipoprotein particle, plasma concentration of CE or plasma concentration of TG.

The term “phenotype” is used herein to mean the result of the occurrence of a series of biological processes. As the biological processes change relative to each other, the phenotype also undergoes changes. One measurement of a phenotype is the level of activity of variables, parameters, and/or biological processes at a specified time and under specified experimental or environmental conditions.

A phenotype can include, for example, the state of an individual cell, an organ, a tissue, and/or a multi-cellular organism. Organisms useful in the methods and models disclosed herein include animals. The term “animal” as used herein includes mammals and humans. A phenotype can also include, but is not limited to, the total triglyceride, total plasma cholesterol, LDL cholesterol, and/or HDL cholesterol present in an animal. These conditions can be imposed experimentally, or can be conditions present in a patient type. For example, a phenotype of total system cholesterol and/or total system triglyceride can include the number of lipoprotein particles present in different lipoprotein classes for a healthy normolipidemic patient. In another example, the phenotype of total system cholesterol and/or total system triglyceride can include the number of lipoprotein particles present in different lipoprotein classes for a dyslipidemic patient. In yet another example, the phenotype of total system cholesterol and/or total system triglyceride can include the number of lipoprotein particles present in different lipoprotein classes for a patient being treated with one or more of the therapeutic agents discussed above.

The term “disease state” is used herein to mean a phenotype where one or more biological processes are related to the cause or the clinical signs of the disease. For example, a disease state can be the state of a diseased cell, a diseased organ, a diseased tissue, or a diseased multi-cellular organism. Examples of diseases that can be modeled include genetic disorders, such as hypertriglyceridemia and hyperlipidemia, metabolic disorders such as non-insulin-dependent diabetes mellitus, metabolic syndrome, fatty liver, and medical conditions associated with an accumulation of one or more lipoprotein particles, such as atherosclerosis. A diseased multi-cellular organism can be, for example, an individual human patient, a group of human patients, or the human population as a whole. A diseased state can also include, for example, a defective enzyme or the accumulation of a class or subclass of lipoprotein particles, such as a deficiency in CETP or the accumulation of VLDL, which may occur in different organs and/tissues.

The term “simulation” is used herein to mean the numerical or analytical integration of a mathematical model. For example, simulation can mean the numerical integration of the mathematical model of the phenotype defined by the above equation, i.e., dx/dt=f(x, p, t).

The term “biological attribute” is used herein to mean biological characteristics of a phenotype, including a disease state. For example, biological attributes of a particular disease state include clinical signs and diagnostic criteria associated with the disease. The biological attributes of a phenotype, including a disease state, can be measurements of biological variables, parameters, and/or processes. Suitable examples of biological attributes associated with a dyslipidemic disease state include, but are not limited to, measurements of total plasma cholesterol, total triglycerides, LDL cholesterol, and HDL cholesterol.

The term “reference pattern” is used herein to mean a set of biological attributes that are measured in a normal or diseased biological system. For example, the measurements may be performed on blood samples, on biopsy samples, or cell cultures derived from a normal or diseased human or animal. Examples of diseased biological systems include cellular or animal models of dyslipidemic phenotypes, and arthrosclerosis.

The term “simulation” is used herein to mean the numerical or analytical integration of a mathematical model. For example, simulation can mean the numerical integration of the mathematical model of the phenotype defined by the above equation, i.e., dx/dt=f(x, p, t).

The term “biological characteristic” is used herein to refer to a trait, quality, or property of a particular phenotype of a biological system. For example, biological characteristics of a particular disease state include clinical signs and diagnostic criteria associated with the disease. The biological characteristics of a biological system can be measurements of biological variables, parameters, and/or processes. Suitable examples of biological characteristics associated with phenotype of cholesterol metabolism include, but are not limited to, measurements of total plasma cholesterol, total triglycerides, LDL cholesterol and HDL cholesterol.

The term “computer-readable medium” is used herein to include any medium which is capable of storing or encoding a sequence of instructions for performing the methods described herein and can include, but not limited to, optical and/or magnetic storage devices and/or disks, and carrier wave signals.

C. Methods of Developing Models of Cholesterol Metabolism

A computer model can be designed to model one or more biological processes or functions. The computer model can be built using a “top-down” approach that begins by defining a general set of behaviors indicative of a biological condition, e.g. a disease. The behaviors are then used as constraints on the system and a set of nested subsystems are developed to define the next level of underlying detail. For example, given a behavior such as elevated plasma cholesterol concentration, the specific mechanisms inducing the behavior each can be modeled in turn, yielding a set of subsystems, which can themselves be deconstructed and modeled in detail. The control and context of these subsystems is, therefore, already defined by the behaviors that characterize the dynamics of the system as a whole. The deconstruction process continues modeling more and more biology, from the top down, until there is enough detail to replicate a given biological behavior. Specifically, the model is capable of modeling biological processes that can be manipulated by a drug or other therapeutic agent.

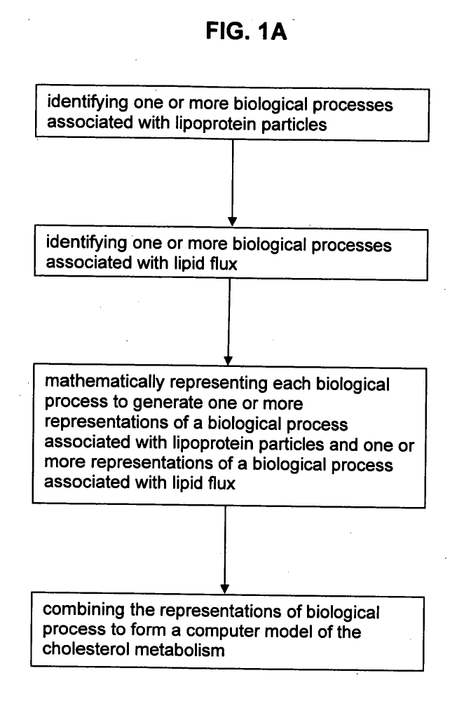

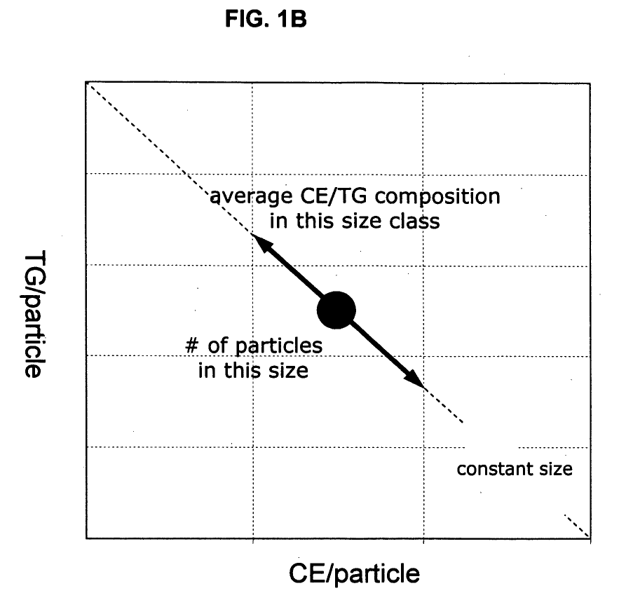

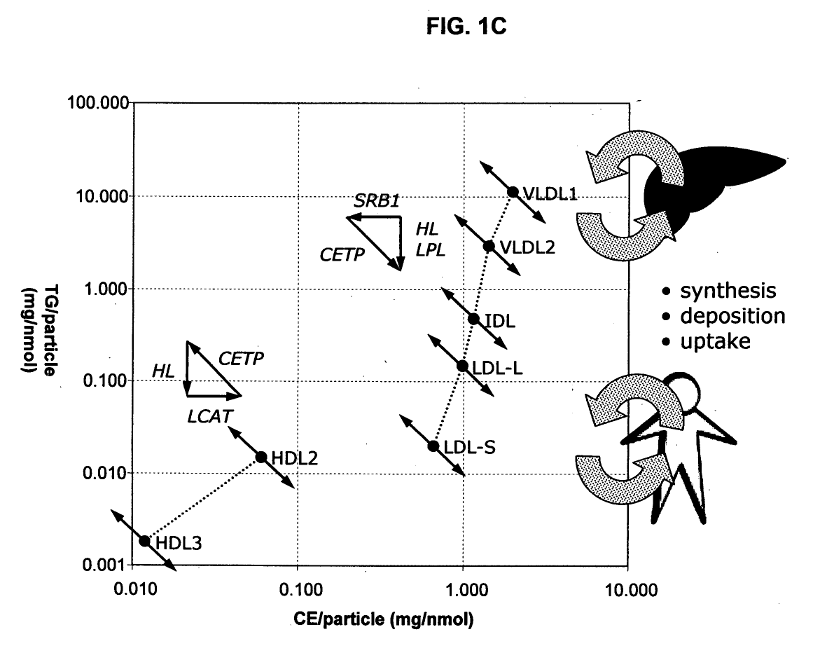

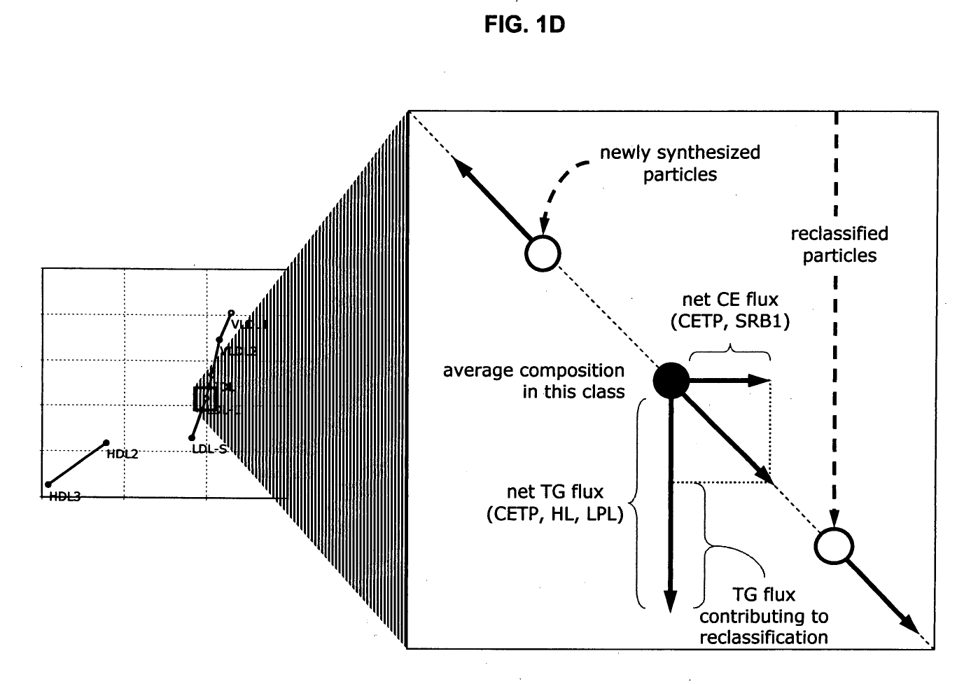

An overview of the methods used to develop computer models of cholesterol metabolism is illustrated in FIG. 1A. The methods typically begin by identifying data associated with cholesterol metabolism in an animal. The methods go on to identify one or more biological processes associated with lipid flux and one or more biological processes associated with lipoprotein particles. The method next comprises the step of mathematically representing each identified biological process. The biological processes can be mathematically represented in any of a variety of manners. Typically, the biological process is defined by the equation, i.e., dx/dt=f(x, p, t), as described below. The representations of the processes associated with the two domains are combined and predictive models of cholesterol metabolism are formed that integrate data for e.g., VLDL, IDL, LDL, and HDL particles, lipoprotein and tissue-associated enzyme and receptor activity, and hepatic lipoprotein particle synthesis to generate a virtual blood cholesterol profile for an animal.

FIG. 3 illustrates various biological processes that relate to cholesterol metabolism in an animal. Two primary domains affect cholesterol metabolism: the lipoprotein particle domain and the lipid molecule domain. Each of these domains is dynamically responsive to changes in the environment and the phenotype of a subject.

In a preferred embodiment, identifying a biological process associated with the lipoprotein particle domain comprises identifying a biological process associated with synthesis, reclassification or catabolism of lipoprotein particles. One or more biological processes can be associated with lipoprotein particle secretion form a hepatic compartment. In a preferred implementation of the invention, the mathematical representation of a biological process associated with lipoprotein particles includes a variable representing a class of lipoprotein particles, a subclass of lipoprotein particles, a number of lipoprotein particles, an apolipoprotein composition of a lipoprotein particle, a cholesteryl ester (CE) content of a lipoprotein particle, a triglyceride (TG) content of a lipoprotein particle, a free cholesterol (FC) content of a lipoprotein particle, a hepatic enzyme, a hepatic receptor, or a therapeutic agent.

The biological processes are selected, such that, when the representations of these biological processes are combined, they are capable of integrating the interactions between lipoprotein particles and lipid molecules in hepatic and peripheral tissues. For example, interactions affecting lipoprotein particle size, number, classification, reclassification, and composition can be integrated and computer models formed that simulate blood cholesterol profiles in healthy and diseased animals. The diseases that can be modeled include genetic disorders, metabolic disorders, and pathological states associated with a perturbation in cholesterol homeostasis.

In some embodiments, methods for developing computer models that simulate cholesterol metabolism comprise identifying biological processes associated with lipid flux between different tissues and particles. The methods include identifying biological processes that affect the flux of lipids between hepatic stores and peripheral tissue stores. Other biological processes of use in the methods described herein include, biological processes associated with the flux of lipids between lipoprotein particles. For example, biological processes involved in the synthesis, catabolism, and reclassification of lipoprotein particles can affect the flux of lipids between the various particles present in a biological system. The biological processes are selected, such that, when combined, they are capable of integrating the interactions affecting lipid flux between the lipoprotein particle domain and the lipid molecule domain.

In some embodiments, methods for developing computer models that simulate cholesterol metabolism comprise identifying biological processes associated with lipoprotein particle synthesis, reclassification or catabolism. Such biological processes include the flux of cholesteryl ester (CE) between newly synthesized lipoprotein particles and existing lipoprotein particles, the flux of triglycerides (TG) between lipoprotein particles, baseline apoB-100 synthesis, the incorporation of lipid from hepatic stores into newly synthesized LDL particles, catabolism of existing particles releasing lipid into hepatic or peripheral lipid stores, and enzyme (e.g. CETP, HL, LPL) or receptor (e.g. SR-B1) mediated removal or addition of lipids to particles. For example, biological processes affecting enzyme and receptor activity in peripheral and hepatic tissue can be identified and computer models formed describing the role of these enzymes in CE and TG flux between lipoprotein particles. The biological processes are selected, such that, when combined, they are capable of integrating the interactions affecting the addition of lipids to lipoprotein particles, as well as the loss of lipids from lipoprotein particles that contribute to particle reclassification.

In some embodiments, cholesterol metabolism can be modeled by identifying cholesterol transport pathways involved in a flux of lipids between and within the lipoprotein particle domain and the lipid molecule domain. In other embodiments, cholesterol metabolism can be modeled by identifying the number and lipid composition of lipoprotein particles in a given class or subclass. In yet other embodiments, cholesterol metabolism can be modeled by identifying the synthesis of lipoprotein particles and the subsequent reclassification of these particles into different lipoprotein classes due to changes in the lipid composition of the particles. In certain implementations, these various methods for modeling cholesterol metabolism will predict the steady-state responses to perturbations in cholesterol homeostasis, but not predict transient changes in cholesterol homeostasis that occur within 24 hours of a stimulus, such as a change in diet or administration of a therapeutic agent. Thus, steady state responses that occur over a number of days or weeks can be modeled using the methods described herein. In an alternative implementation, the model of cholesterol metabolism can simulate transient dynamics associated with cholesterol metabolism, such as those which occur following food intake (post-prandial dynamics).

In some implementations, the methods comprise identifying biological processes associated with lipoprotein particles, wherein the lipoprotein particles are assigned a particular class or subclass. FIG. 1B illustrates an exemplary method of partitioning particles into a certain class or subclass. In this implementation, a class or subclass of particles is defined by the size of particles within that class. The particle size is determined by quantifying the volume of cholesterol and triglyceride contained within the particle. Thus a particular class will contain particles all having the same size, i.e., the same amount of total lipid even though the amount of cholesterol or triglyceride will vary from particle to particle within the class. In one implementation of the model, if the lipid content of a particle exceeds the maximum lipid content which satisfies the iso-size constraint for its particle class, the particle is reclassified to another, larger, particle class. Similarly, if the total lipid content of a particle is less than the minimal lipid content necessary to satisfy the iso-size constraint of its particle class, the particle is reclassified to a smaller class, thus maintaining the constant size of particles within a particle class or subclass.

In certain implementations, the model of cholesterol metabolism is capable of simulating a biological system at homeostasis, wherein cholesterol synthesis, deposition and uptake are all in balance. An example of a biological system in homeostasis is a human subject after an overnight fast. FIG. 1C illustrates several biological components that preferably are considered in developing a model of cholesterol metabolism at homeostasis. Thus the flux of lipids between particles and the liver, between peripheral tissues (illustrated by human figure) and particles and between particles of different classes preferably are modeled. Further, it is preferable that the CE and TG content in the various lipoprotein particle subclasses are modeled. As illustrated in FIG. 1C and discussed in more detail below, the CE and TG content of a given lipoprotein class or subclass can be affected by the activity of specific enzymes, e.g., CETP, LCAT, HL, LPL, and scavenger receptors (e.g., SR-B1), located in peripheral and hepatic tissue, as well as by synthesis of new LDL particles in the hepatic tissue compartment or formation of new HDL particles by cholesterol uptake from peripheral tissue, and by catabolism of LDL or HDL particles by these compartments. At homeostasis, the cholesterol flux is in balance. Application of a virtual protocol, e.g., a chronic virtual therapy, that alters any parameter or component of the model is expected to perturb the system towards a new homeostatic condition characterized by an altered number and distribution of particles, as well as cholesterol content of the particles, hepatic, and peripheral compartments.

FIG. 1D illustrates the behavior of a single subclass of lipoprotein particles in one implementation of the invention. Within a subclass of lipoprotein particles, the lipid content of a particle is subject to the activity of several enzymes. Typically, net particle cholesterol content increases due to the combined action of CETP and SR-B1, while net particle triglyceride content decreases due to the combined action of CETP, HL and LPL. Thus, as illustrated, the general movement of particles within a class is down the size isobar in the absence of any additional contribution to the average TG and CE content of a particle in a specific class. An equilibrium state of TG and CE content within a particle class can only be maintained by the addition of particles having high triglyceride and low cholesterol content. This requirement is fulfilled by the new synthesis of such high-TG, low-CE particles by hepatic or peripheral tissue, consistent with reports from the literature. Further, FIG. 1D illustrates that net triglyceride flux not only contributes to movement along the size isobar, but also contributes to reclassification of particles by removing enough triglyceride to reduce the total lipid content of the particle below the bounds of the defined subclass. Accordingly, triglyceride flux is important to reclassifying particles to smaller particle classes or subclasses. While reclassification is predominantly to smaller classes, particles can be reclassified “up” or “down” in size depending on factors such as net CE and TG flux, and the net action of various enzymes that affect the CE and TG content of a given lipoprotein particle.

FIG. 1D illustrates the behavior of a single subclass of lipoprotein particles in one implementation of the invention. Within a subclass of lipoprotein particles, the lipid content of a particle is subject to the activity of several enzymes. Typically, net cholesterol content increases due to CETP and SR-B1 activity, while net triglyceride content decreases due to CETP, HL and LPL activity. Thus, as illustrated, the general movement of particles within a class is down the size isobar. The mass balance of particle class can only be maintained by the addition of particles having high triglyceride and low cholesterol content. This requirement is fulfilled by the new synthesis of such high-TG, low-CE particles by hepatic or peripheral tissue. Further, FIG. 1D illustrates that net triglyceride flux not only contributes to movement along the size isobar, but also contributes to reclassification of particles by removing so much triglyceride that the total lipid content of the particle is lower than the bounds of defined subclass. Accordingly, triglyceride flux is important to reclassifying particles to smaller particle classes or subclasses. While reclassification is predominantly to smaller classes, particles can be reclassified “up” or “down” in size depending on factors such as net CE and TG flux, and the net action of various enzymes that affect the CE and TG content of a given lipoprotein particle.

Once one or more biological processes are identified in the context of the methods of the invention, each biological process is mathematically represented. For example, the computer model can represent a first biological process using a first mathematical relation and a second biological process using a second mathematical relation. A mathematical relation typically includes one or more variables, the behavior (e.g., time evolution) of which can be simulated by the computer model. More particularly, mathematical relations of the computer model can define interactions among variables describing levels or activities of various biological components of the biological system as well as levels or activities of combinations or aggregate representations of the various biological components. In addition, variables can represent various stimuli that can be applied to the biological system. The mathematical model(s) of the computer-executable software code represents the dynamic biological processes related to cholesterol metabolism. The form of the mathematical equations employed may include, for example partial differential equations, stochastic differential equations, differential algebraic equations, difference equations, cellular automata, coupled maps, equations of networks of Boolean or fuzzy logical networks, etc.

In some embodiments, the mathematical equations used in the model are ordinary differential equations of the form:
dx/dt=f(x,p,t)
where x is an N dimensional vector whose elements represent characteristics of the biological components of the system, t is time, dx/dt is the rate of change of x, p is an M dimensional set of system parameters, and f is a function that represents the complex interactions among biological variables. In one implementation, the parameters are used to represent intrinsic characteristics (e.g., genetic factors) as well as external characteristics (e.g., environmental factors) for a biological system

In some embodiments, the phenotype can be mathematically defined by the values of x and p at a given time. Once a phenotype of the model is mathematically specified, numerical integration of the above equation using a computer determines, for example, the time evolution of the biological variables x(t) and hence the evolution of the phenotype over time.

The representations of the biological processes are combined to generate a model of cholesterol metabolism. Generation of models of biological systems are described, for example, in U.S. Pat. Nos. 5,657,255 and 5,808,918, entitled “Hierarchical Biological Modeling System and Method”; U.S. Pat. No. 5,914,891, entitled “System and Method for Simulating Operation of Biochemical Systems”; U.S. Pat. No. 5,930,154, entitled “Computer-based System and Methods for Information Storage, Modeling and Simulation of Complex Systems Organized in Discrete Compartments in Time and Space”; U.S. Pat. No. 6,051,029, entitled “Method of Generating a Display for a Dynamic Simulation Model Utilizing Node and Link Representations”; U.S. Pat. No. 6,069,629, entitled “Method of Providing Access to Object Parameters Within a Simulation Model”; U.S. Pat. No. 6,078,739, entitled “A Method of Managing Objects and Parameter Values Associated With the Objects Within a Simulation Model”; U.S. Pat. No. 6,539,347, entitled “Method of Generating a Display For a Dynamic Simulation Model Utilizing Node and Link Representations”; U.S. Application Publication No. 20010032068, entitled “Method and Apparatus for Conducting Linked Simulation Operations Utilizing a Computer-Based System Model”; and PCT publication WO 99/27443, entitled “A Method of Monitoring Values within a Simulation Model”. The representations, when combined, integrate the interactions described by each biological process to form a model capable of simulating cholesterol metabolism by including both particle dynamics and lipid flux in the model, the model is capable of simulating the lipid balance found in a real subject.

The methods can further comprise methods for validating the computer models described herein. For example, the methods can include generating a simulated biological attribute associated with cholesterol metabolism in an animal, and comparing the simulated biological attribute with a corresponding reference biological attribute measured in a normal or diseased animal. The result of this comparison in combination with known dynamic constraints may confirm some part of the model, or may point the user to a change of a mathematical relationship within the model, which improves the overall fidelity of the model.

D. Computer Models of Cholesterol Metabolism

Provided herein are models, useful for, among other things, modeling cholesterol metabolic pathways in animals. In some embodiments, the models are computer models that simulate cholesterol metabolism in an animal. In other embodiments, mathematical models are used to describe processes affecting cholesterol metabolism. For example, computer models can be formed by combining biological processes associated with different biological domains, e.g., the lipoprotein particle domain and the lipid molecule domain, that affect cholesterol metabolism in an animal. The mathematical models can be formed by identifying mathematical relations among the biological variable associated with one or more of the biological processes associated with the lipoprotein particle domain and/or the lipid molecule domain and integrating these values to define a phenotype associated with cholesterol metabolism.

The methods of developing models of cholesterol metabolism described above may be used to generate a model that may include hundreds or even thousands of objects, each of which may include a number of parameters. In order to perform effective “what-if” analyses using a simulation model, it is useful to access and observe the input values of certain key parameters prior to performance of a simulation operation, and also possibly to observe output values for these key parameters at the conclusion of such an operation. As many parameters are included in the expression of, and are affected by, a relationship between two objects, a modeler may also need to examine certain parameters at either end of such a relationship. For example, a modeler may wish to examine parameters that specify the effects a specific object has on a number of other objects, and also parameters that specify the effects of these other objects upon the specific object. Complex models are also often broken down into a system of sub-models, either using software features or merely by the modeler's convention. It is accordingly often useful for the modeler simultaneously to view selected parameters contained within a specific sub-model. The satisfaction of this need is complicated by the fact that the boundaries of a sub-model may not be mutually exclusive with respect to parameters, i.e., a single parameter may appear in many sub-models. Further, the boundaries of sub-models often change as the model evolves.

The created computer model represents biological processes at multiple levels and then evaluates the effect of the biological processes on biological processes across all levels. Thus, the created computer model provides a multi-variable view of a biological system. The created computer model also provides cross-disciplinary observations through synthesis of information from two or more disciplines into a single computer model or through linking two computer models that represent different disciplines.

An exemplary computer model reflects a particular biological system, and anatomical factors relevant to issues to be explored by the computer model. The level of detail incorporated into the model is often dictated by a particular intended use of the computer model. For example, biological components being evaluated, e.g. the enzyme CETP, often operate at a subcellular level; therefore, the subcellular level can occupy the lowest level of detail represented in the model. The subcellular level includes, for example, biological components such as DNA, mRNA, proteins, chemically reactive molecules, and subcellular organelles. Similarly, the model can be evaluated at the multicellular level, e.g. hepatic tissue, or even at the level of a whole organism. Because an individual biological system, e.g. a single human, is a common entity of interest with respect to the ultimate effect of the biological components, the individual biological system (e.g., represented in the form of clinical outcomes) is the highest level represented in the system. Disease processes and therapeutic interventions are introduced into the model through changes in parameters at lower levels, with clinical outcomes being changed as a result of those lower level changes, as opposed to representing disease effects by directly changing the clinical outcome variables.

In one implementation, simulation modeling software is used to provide a computer model, e.g., as described in U.S. Pat. No. 5,657,255, issued Aug. 12, 1997, titled “Hierarchical Biological Modeling System and Method”; U.S. Pat. No. 5,808,918, issued Sep. 15, 1998, titled “Hierarchical Biological Modeling System and Method”; U.S. Pat. No. 6,051,029, issued Apr. 18, 2000, titled “Method of Generating a Display for a Dynamic Simulation Model Utilizing Node and Link Representations”; U.S. Pat. No. 6,539,347, issued Mar. 25, 2003, titled “Method of Generating a Display For a Dynamic Simulation Model Utilizing Node and Link Representations”; U.S. Pat. No. 6,078,739, issued Jan. 25, 2000, titled “A Method of Managing Objects and Parameter Values Associated With the Objects Within a Simulation Model”; and U.S. Pat. No. 6,069,629, issued May 30, 2000, titled “Method of Providing Access to Object Parameters Within a Simulation Model”. An example of simulation modeling software is found in U.S. Pat. No. 6,078,739.

Various diagrams can be used to illustrate the dynamic relationships among the elements of the phenotype. Examples of suitable diagrams include Effect and Summary Diagrams. See, e.g., U.S. Pat. No. 6,862,561, entitled “Method and Apparatus for Computer Modeling a Joint”, the disclosure of which is incorporated herein by reference.

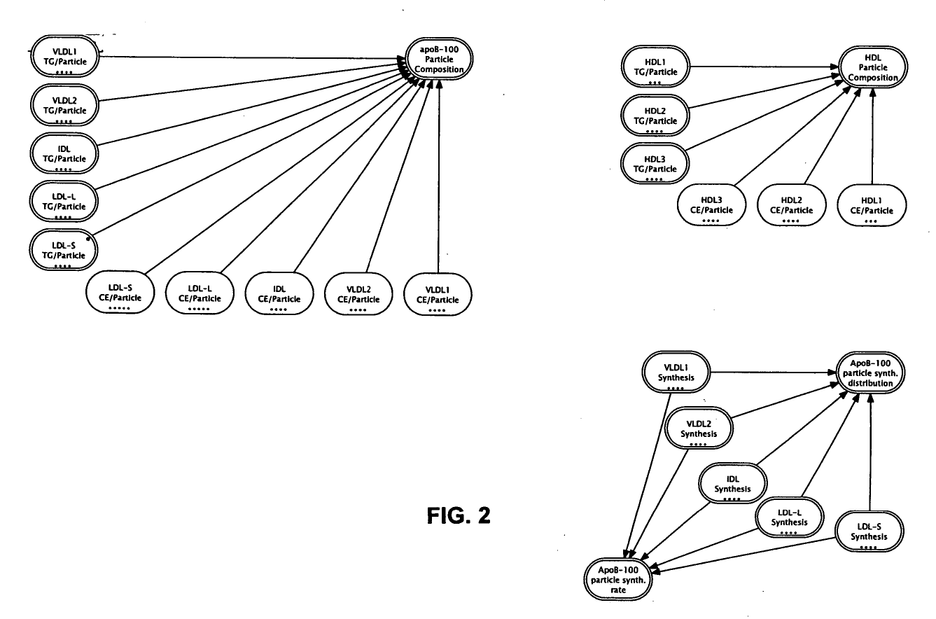

An Effect Diagram can be a visual representation of the model equations and illustrate the dynamic relationships among the elements of the phenotype. FIG. 2 illustrates an example of an Effect Diagram, in which the cholesterol ester (CE) and triglyceride (TG) content of each particle class is computed and plotted at each time point during a simulation. The Effect Diagram is organized into modules, or functional areas, which when grouped together represent the large complex physiology of the phenotype being modeled.

The Summary Diagram can provide an overview of the various pathways modeled in the methods and models described herein. For example, the Summary Diagram illustrated in FIG. 3 provides an overview of cholesterol transport pathways that can affect cholesterol metabolism. The Summary Diagram can also provide links to individual modules of the model. The modules model the relevant components of the phenotype through the use of “state” and “function” nodes whose relations are defined through the use of diagrammatic arrow symbols. Thus, the complex and dynamic mathematical relationships for the various elements of the phenotype are easily represented in a user-friendly manner. In this manner, a normal phenotype can be represented.

FIG. 2 illustrates an example of one of the module diagrams depicted in FIG. 3. The module diagram illustrated in FIG. 2 discloses various synthetic, catabolic and reclassification processes involving ApoB-100 particles. Relevant biological variables and biological processes for involving ApoB-100 particles are represented through the use of state and function nodes whose relations are defined through the use of diagrammatic arrow symbols. The use of state nodes, function nodes, and arrows, permits the representation of the complex and dynamic mathematical relationships for the various elements of the physiologic system to be displayed in a user-friendly manner.

State and function nodes show the names of the variables they represent and their location in the model. The arrows and modifiers show the relationship of the state and function nodes to other nodes within the model. State and function nodes also contain the parameters and equations that are used to compute the values of the variables the represent in simulated experiments. In some embodiments, the state and function nodes are represented according to the method described in U.S. Pat. No. 6,051,029 and co-pending application Ser. No. 09/588,855, both of which are entitled “Method of generating a display for a dynamic simulation model utilizing node and link representations,” and are incorporated herein by reference. Further examples of state and function nodes are further discussed below.

State nodes are represented by single-border ovals and represent variables in the system, the values of which are determined by the cumulative effects of inputs over time (see, e.g., FIG. 3). “Input” refer to any parameter that can affect the variable being modeled by the state node. For example, input for a state node representing CE/particle can be CETP enzymatic activity or SR-B1 receptor activity. State node values are defined by differential equations. The predefined parameters for a state node include its initial value (S₀) and its status. In some embodiments, state nodes can have a half-life. In these embodiments, a circle containing an “H” is attached to the node that has a half-life.

Function nodes are represented by double-border ovals and represent variables in the system, the values of which, at any point in time, are determined by inputs at the same point in time. Function nodes are defined by algebraic functions of their inputs. The predefined parameters for a function node include its initial value (F₀) and its status. Setting the status of a node effects how the value of the node is determined. The status of a state or function node can be: 1) Computed—the value is calculated as a result of its inputs; 2) Specified-Locked—the value is held constant over time; and, 3) Specified Data the value varies with time according to predefined data points. Function node equations are computed by evaluating the specified function of the values of the nodes with arrows pointing into the function node (arguments). See, e.g., U.S. Pat. No. 6,862,561, entitled “Method and Apparatus for Computer Modeling a Joint”, the disclosure of which is incorporated herein by reference, for a discussion of the computation of function node equations.

State and function nodes can appear more than once in the module diagram as alias nodes. Alias nodes are indicated by one or more dots (see, e.g., state node VLDL1 Particles in FIG. 3). State and Function nodes are also defined by their position, with respect to arrows and other nodes, as being either source nodes (S) or target nodes (T). Source nodes are located at the tails of arrows and target nodes are located at the heads of arrows. Nodes can be active or inactive. See, e.g., U.S. Pat. No. 6,862,561, entitled “Method and Apparatus for Computer Modeling a Joint”, the disclosure of which is incorporated herein by reference, for a discussion of the computations status of a state node.

Arrows link source nodes to target nodes and represent the mathematical relationship between the nodes. Arrows can be labeled with circles that indicate the activity of the arrow. A key to the annotations in the circles is located in the upper left corner of each Effect Diagram. If an arrowhead is solid, the effect is positive. If the arrowhead is hollow, the effect is negative. For further description of arrow types, arrow characteristics, and arrow equations, see, e.g., U.S. Pat. No. 6,862,561, entitled “Method and Apparatus for Computer Modeling a Joint”, the disclosure of which is incorporated herein by reference.

Metabolism of cholesterol involves two distinct domains: lipoprotein particles that facilitate the intravascular transport of hydrophobic lipids between hepatic and peripheral tissues, and the lipid molecules themselves. Lipoprotein particles consist of two major classes: apoB-100 particles synthesized and secreted by the liver, including very low-density lipoproteins (VLDL), intermediate density lipoproteins (IDL), and low-density lipoproteins (LDL); and apoA particles, also called high-density lipoproteins (HDL). Lipid molecules include free and esterified cholesterol (FC and CE, respectively) and triglycerides (TG), which are packaged by the liver into lipoprotein particles. Lipoprotein particles are secreted by the liver into the bloodstream, once in the bloodstream they can be acted upon by peripheral tissue enzymes that remove TG and CE. Particle remnants are subsequently catabolized by specific receptors and degraded, typically in the liver. These enzymatic and receptor-mediated changes affect the particle number, size, and classification, as well as the concentration of lipids intravascularly and in tissues.

The lipid molecule domain relates to the flux of lipid between various biological compartments and lipoprotein particles. Lipid molecules can be described as primarily residing in one of three compartments: the liver (hepatic liver stores), lipoprotein particles, or the remainder of the body including the circulation (peripheral lipid stores). Additional compartments relating to cholesterol uptake (e.g. an intestinal compartment) or secretion can also be included in the model.

To effectively capture the complex interactions between the lipoprotein particle domain and the lipid molecule domain, the methods comprise combining biological processes that occur in both domains. These biological processes incorporate core components in in vivo pathways underlying lipoprotein particle number and lipid composition, i.e., the lipoprotein particle domain or compartment, with core components in in vivo pathways underlying the transport of lipid molecules between hepatic and peripheral tissue, i.e., the lipid molecule domain or compartment. The resulting computer models can provide predictive representations of cholesterol metabolism in healthy and/or diseased animals. The models can simulate perturbations in cholesterol metabolism in response to dietary changes, therapeutic agents, metabolic disorders, etc., in healthy and diseased animals. Comparisons between the models can be used, for example, to predict the lipoprotein particle profile and plasma lipid profile in healthy versus diseased animals. Other uses include, but are not limited to, comparing the effect of various therapeutic agents on the lipoprotein particle profile and plasma lipid profile in healthy versus diseased animals. Comparison with clinical data can be used to fine-tune the core components of the computer models.

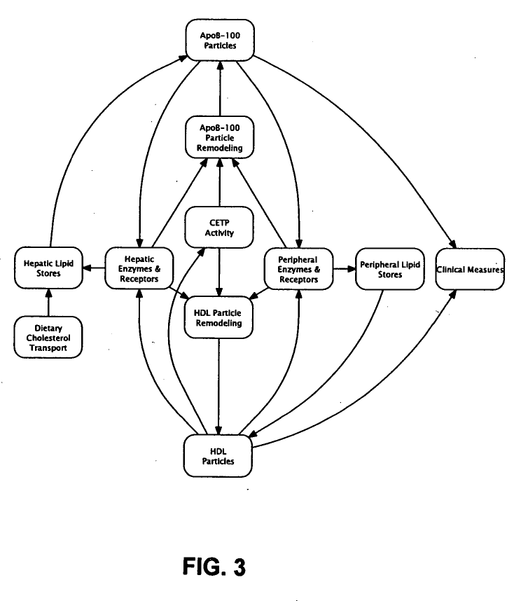

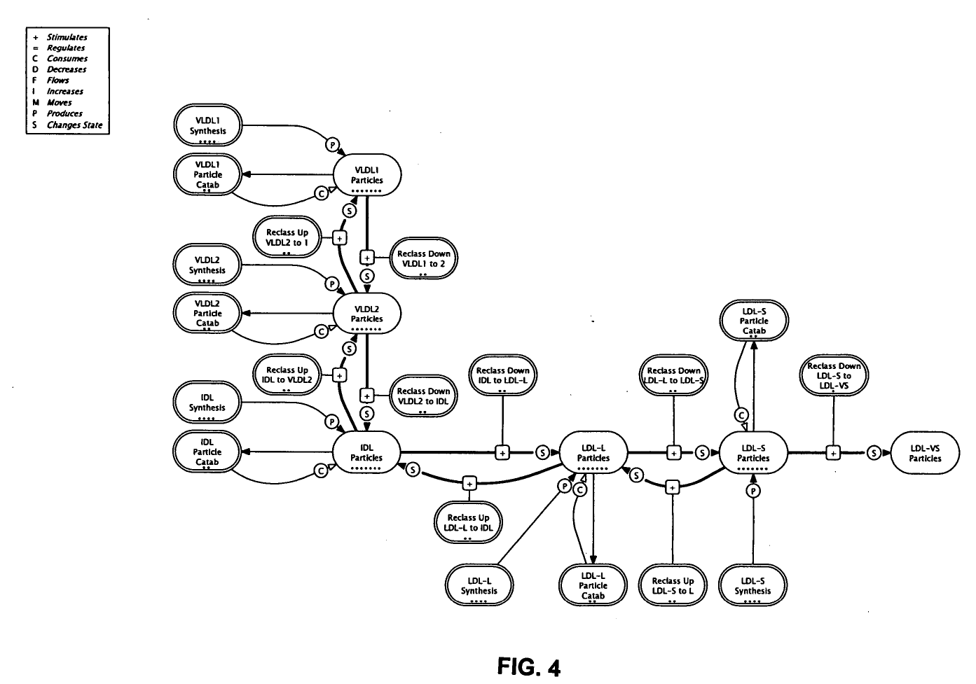

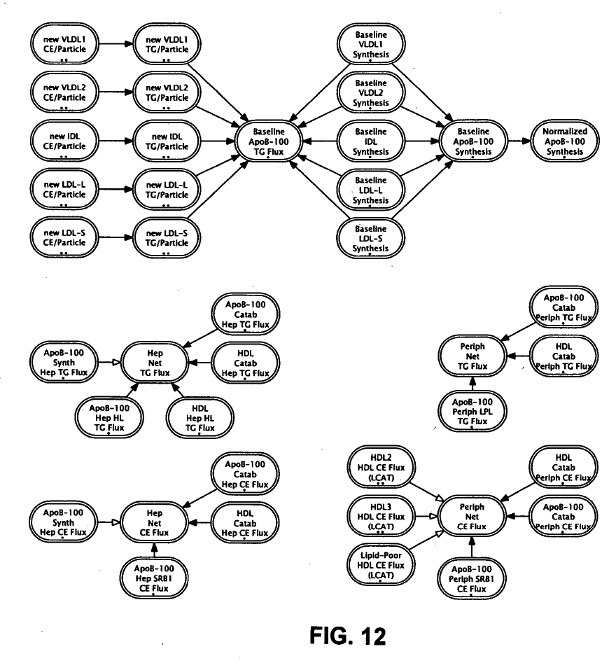

Any number of biological processes associated with cholesterol metabolism can be incorporated into the methods and models described herein. In addition, additional processes can be incorporated into the existing models. FIG. 3 depicts a number of “state” nodes that link to modules that model biological variables and processes that can affect cholesterol metabolism: 1) dietary cholesterol transport (cholesterol intake); 2) hepatic lipid stores; 3) ApoB-100 particles; 4) hepatic enzymes and receptors; 5) ApoB-100 particle remodeling; 6) CETP activity; 7) HDL particle remodeling; 8) HDL particles, 9) peripheral enzymes and receptors; 10) peripheral lipid stores and, 11) clinical measures. Modules depicting the processes modeled for each of the listed state nodes are illustrated in FIGS. 4-14.

As illustrated in the FIG. 3, generally the methods begin by with the uptake of dietary free cholesterol (FC). Dietary FC is absorbed and transported into the hepatic compartment. FC can be irreversibly converted to bile, or esterified into cholesterol ester (CE) and packaged with triglyceride (TG) into apoB-100 lipoprotein particles and secreted into the bloodstream for transport to peripheral tissues. Reverse cholesterol transport from the peripheral tissues to the hepatic compartment can occur via HDL particle uptake of peripheral tissue cholesterol, or receptor-mediated uptake of apoB-100 particle remnants left over following peripheral tissue enzymatic activity.

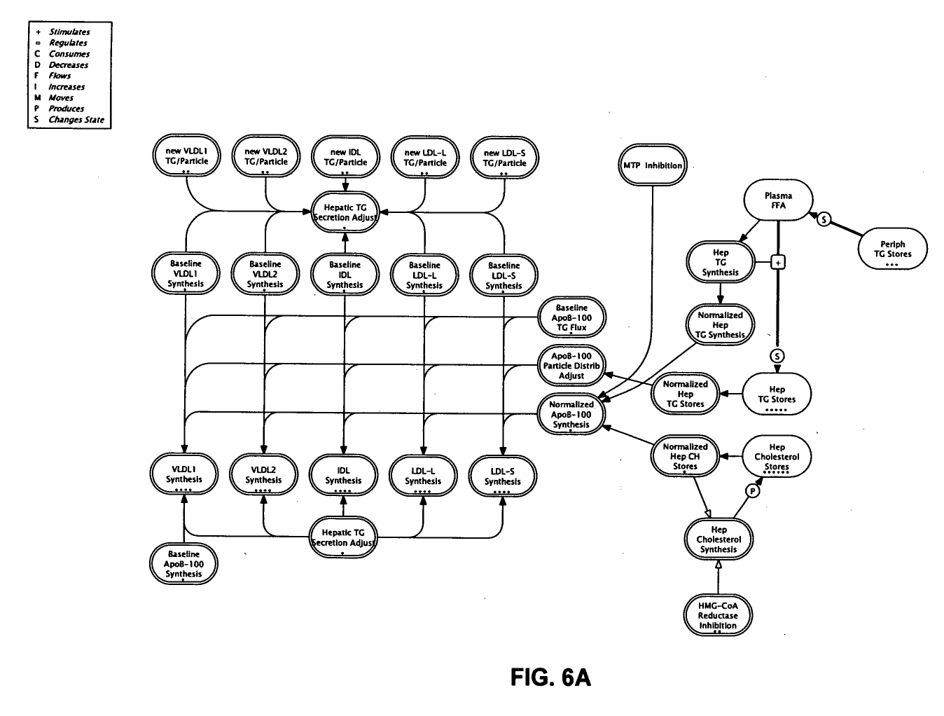

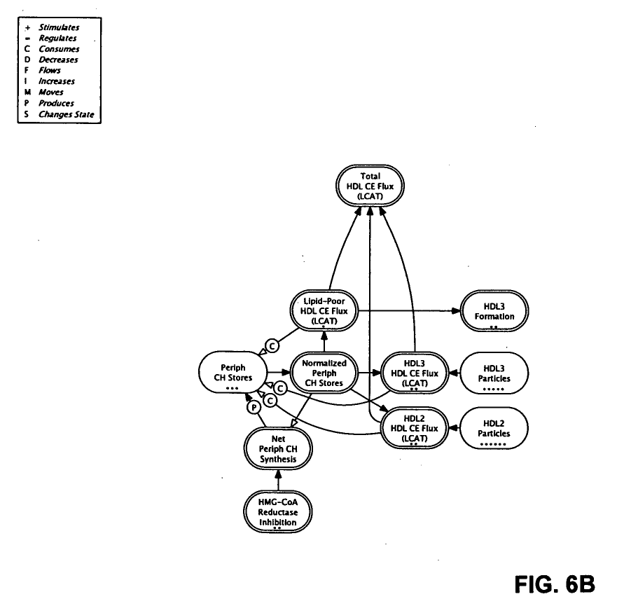

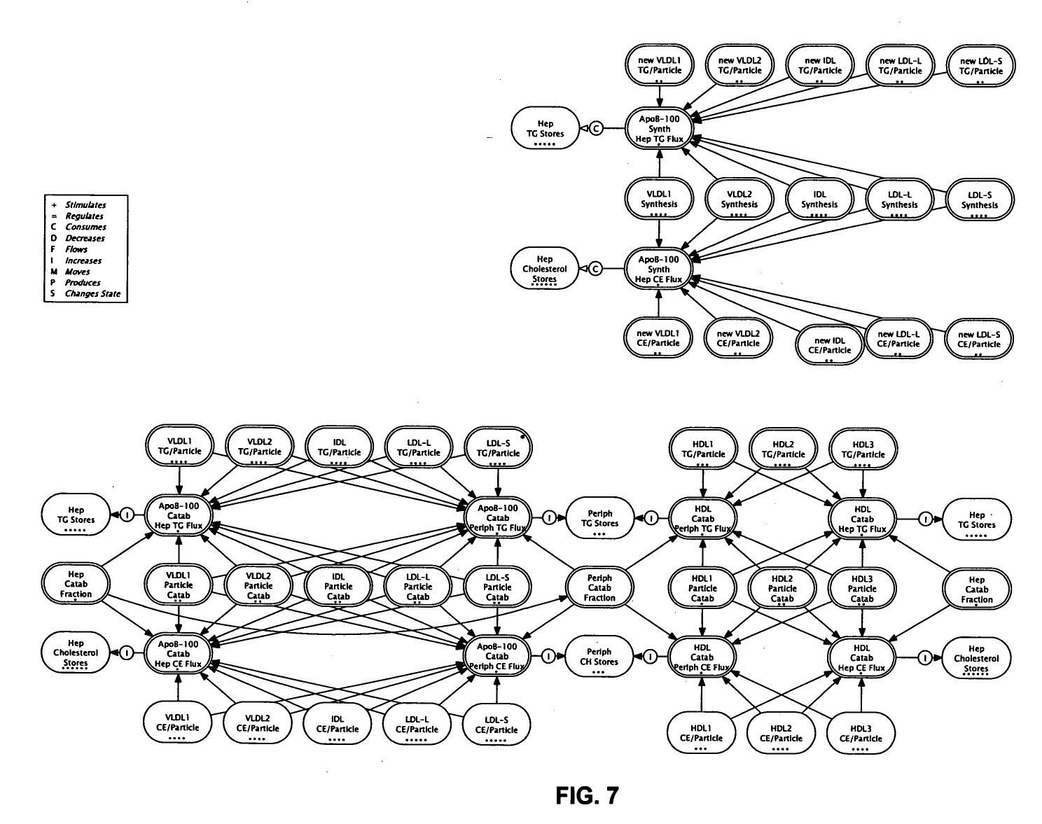

FIG. 4 illustrates one of the modules that model core biological components for ApoB-100 particles. ApoB-100 particles form one of the two major classes of lipoprotein particles. ApoB-100 particles are composed of varying ratios of triglyceride (TG), cholesterol ester (CE), free cholesterol (FC) and phospholipid (PL). As illustrated in FIG. 6A, ApoB-100 particles are synthesized in the liver, packaged and secreted into the bloodstream. The module depicted in FIG. 7 describes the various processes involved in the catabolism of these particles in both the hepatic and peripheral tissue compartments.

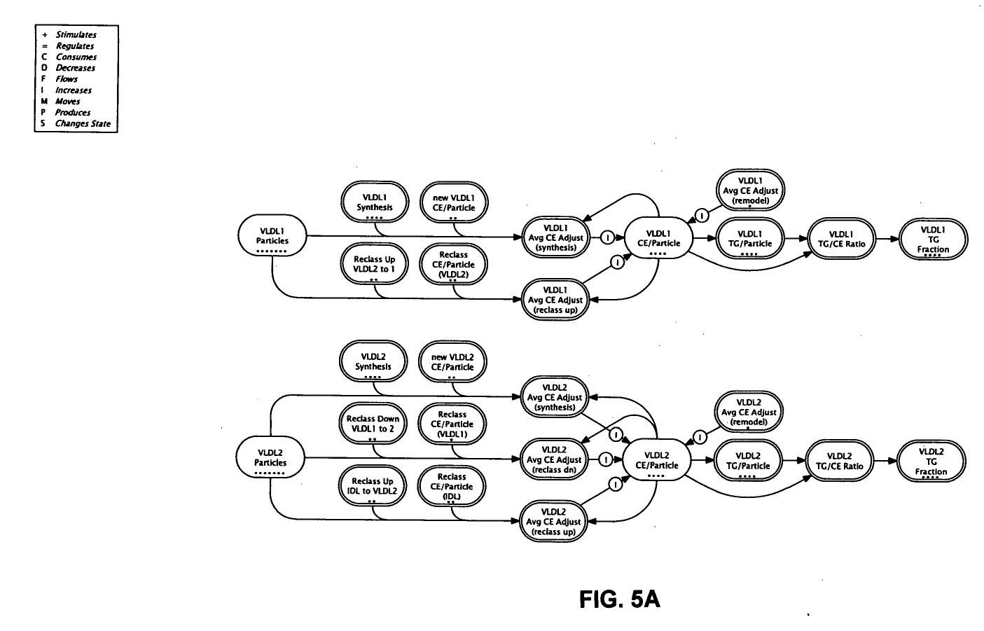

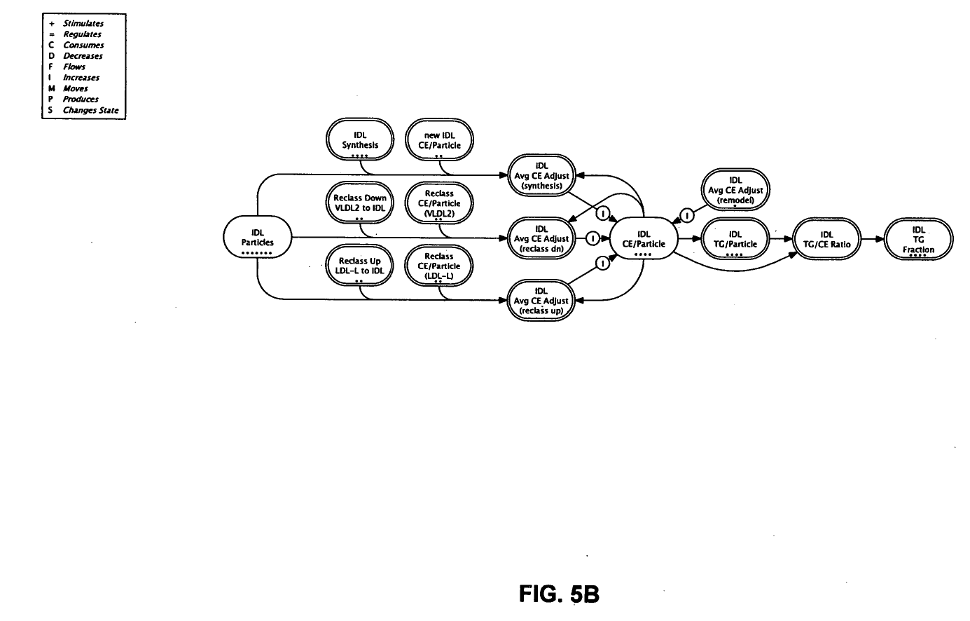

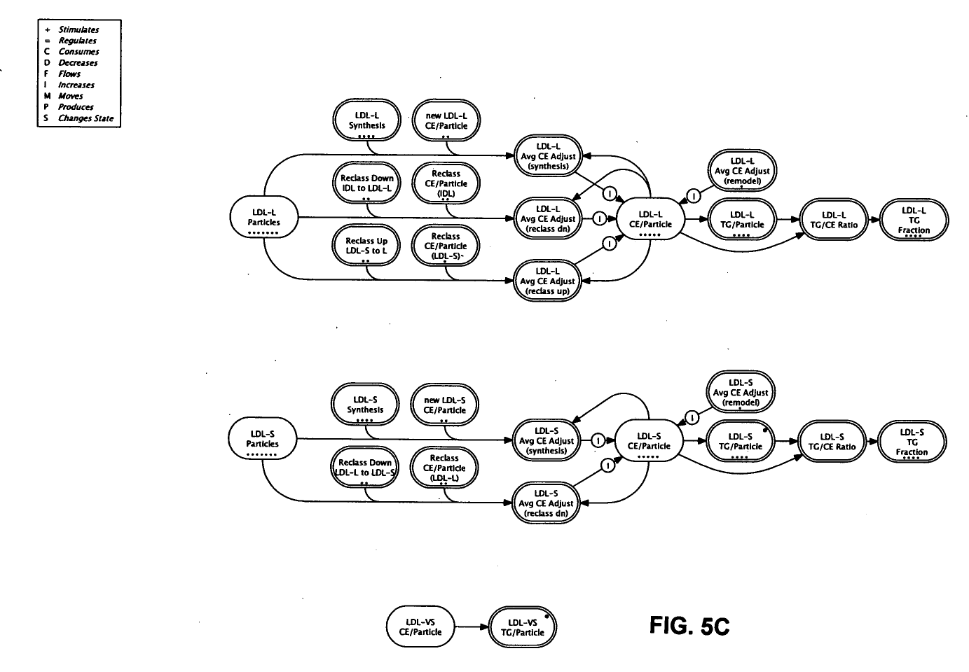

As illustrated in FIG. 4, VLDL, IDL and LDL particles are linked in a continuous metabolic cascade in which lipid (mainly triglyceride) can be added or lost in a series of small lipolytic steps. VLDL, IDL and LDL are synthesized and secreted continuously by the liver. Lipoprotein assembly is initiated by the addition of lipid to the growing apoB chain in the rough endoplasmic reticulum. More lipid, principally triglyceride, is added to nascent particles as they pass along the secretory pathway (see, e.g., Packard and Shepherd, 1997, supra, and references cited within). Additional biological variables and processes affecting the synthesis, catabolism and remodeling of VLDL, IDL and LDL particles are illustrated in FIGS. 5A-5C.

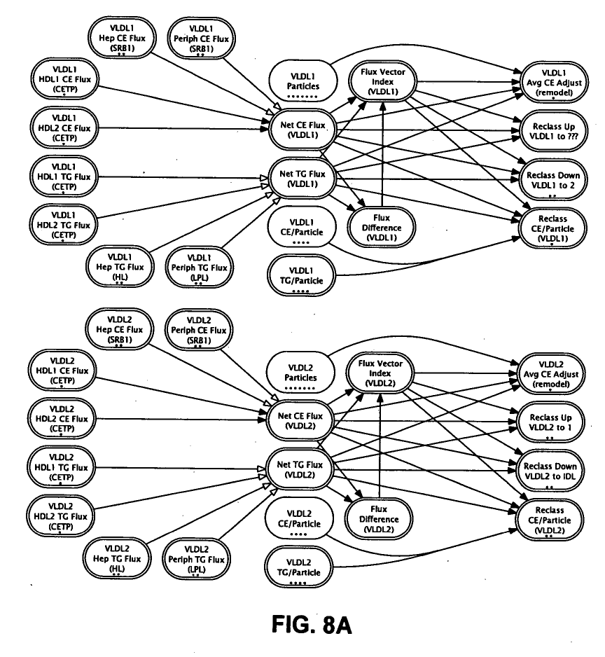

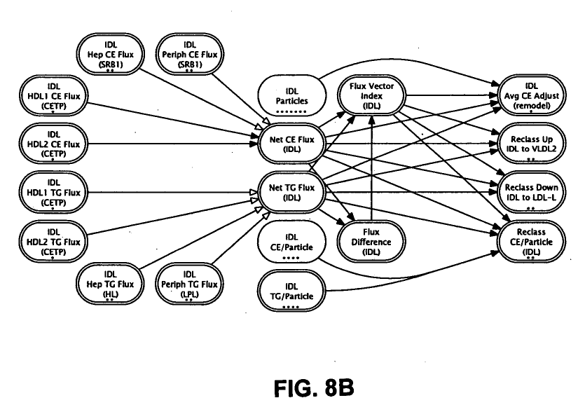

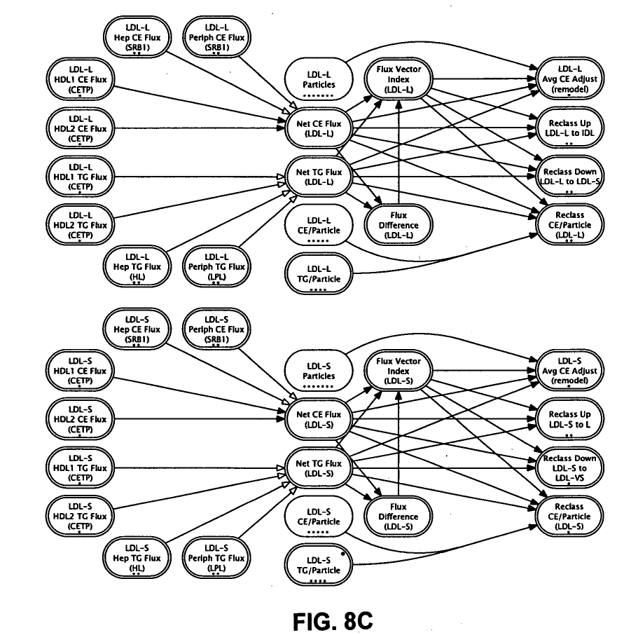

ApoB-100 particles can be fractionated into three major classes, i.e., VLDL, IDL, and LDL. The three major classes can be fractioned into additional classes defined by their size. VLDL particles vary in size from about 350 angstroms to 700 angstroms diameter. Most of the difference in size is due to the triglyceride core. Within the 350 angstroms to 700 angstroms diameter range, two or three additional subfractions have been identified: VLDL₁ of S_{f} 60 to 400 and VLDL₂ S_{f} 20 to 60, or alternatively VLDL₁ of S_{f} 100 to 400, VLDL₂ S_{f} 60 to 100, and VLDL₃ S_{f} 20 to 60. IDL particles vary in size from 270 to 300 angstroms. Although two subfractions have been identified, they are similar in size and density, and hence cannot be readily isolated. LDL particles vary in size from 200 to 270 angstroms. Within the 200 angstroms to 270 angstrom diameter range, three additional subfractions have been identified: LDL-1, density (d)=1.025 g/ml to 1.034 g/ml; LDL-II. D=1.034 g/ml to 1.044 g/ml, LDL-III, d=1.044 g/ml to 1.060 g/ml (see, e.g., Packard and Shepherd, 1997, supra). In one implementation of the invention, the size of a particle is a measure of the volume of the particle. The particle diameter and volume is calculated assuming that each particle is a sphere. Given, the total volume is calculated based on an average density for CE and TG in the particle, a total mass of CE and TG, and an average protein content per particle. Thus the size of a particle is correlated to lipid as well as protein content. The modules illustrated in FIGS. 8A-C depict the effect of various enzymatic activity on the flux of lipids between the various particles and how changes in lipid content affect the reclassification of these particles.

Reclassification and remodeling of apoB-100 particles is carried out by the action of LPL, HL, and SR-B1. These enzymes alter the TG and CE content of each particle and, hence, contribute to changes in particle size as previously described. Modules, in which the overall action of enzymes are combined into a net CE and net TG flux affecting each particle class separately are depicted in FIGS. 8A-8C (“Net CE Flux” and “Net TG Flux”). These fluxes affect the average CE and TG content of each particle class from the equilibrium values (“Avg CE adjust-remodel”). Large particles are thus reclassified into small ones or vice versa (“Avg CE Adjust-reclass up” and “Avg CE Adjust-reclass down”).

The apoB-100 particle lipoprotein composition for a reference virtual patient can be determined by analyzing and integrating data from literature reports or experimental protocols. Values are compiled for each particle class for the following parameters: 1) CE and TG per particle; 2) rates of hepatic synthesis and catabolism; 3) number of particles. In homeostatic situations, e.g. following an overnight fast, CE and FC are considered to be equivalent due to the relatively fast dynamics of interconversion. Furthermore, the state variable CE/particle is tracked for each particle class (see, e.g., FIGS. 5A-5C). TG/particle is calculated based upon the constraint that particles in a specific class remain at a specified “mean” size, determined from reports in the literature. Changes to particle composition that alter the particle size effect a reclassification of the particle into a different class. Particle size can be determined by a number of different methods, including density gradient centrifugation, electrophoresis, affinity chromatography and NMR. Generally, NMR is used to determine particle number. Other means of determining particle number include the use of radiolabeled tracer studies combined with centrifugation. As will be appreciated by a person skilled in the art, different numbers of particles will be obtained using different methods.

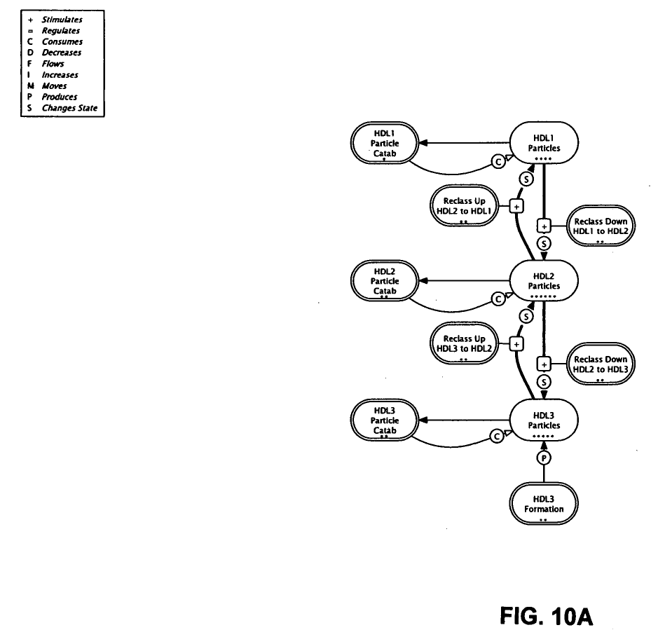

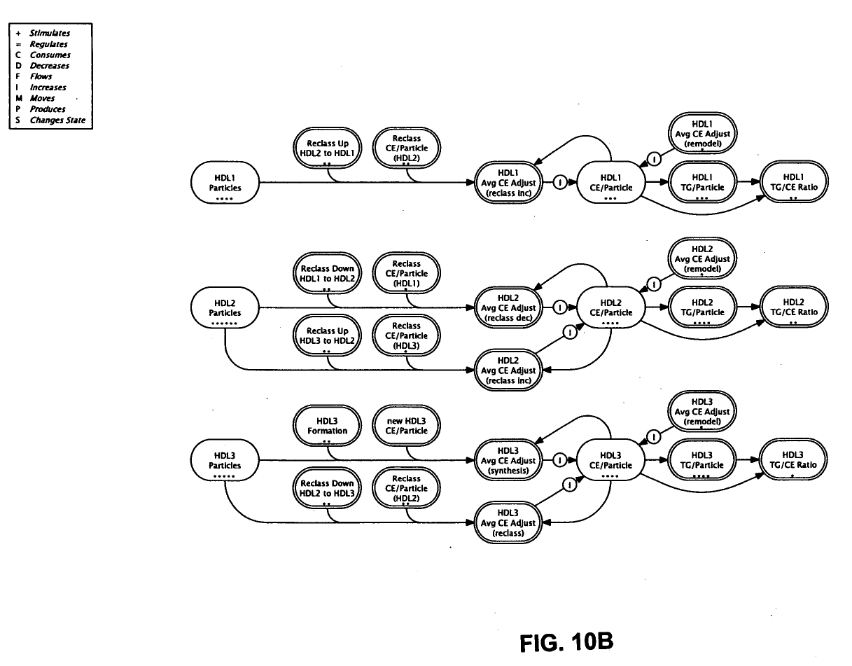

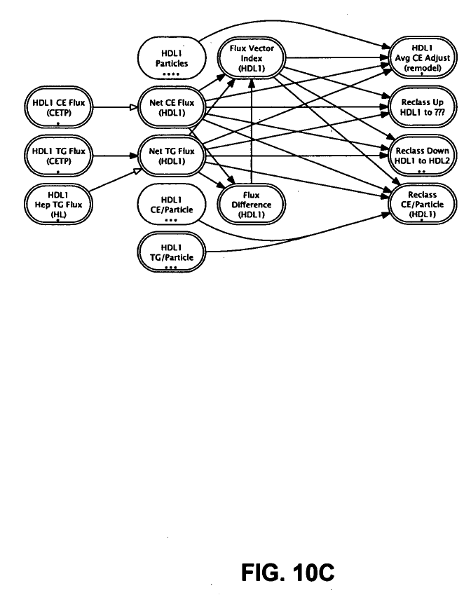

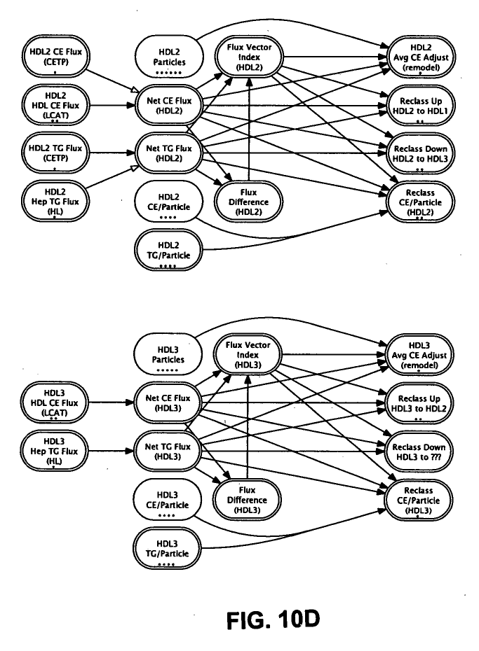

FIGS. 10A-10D illustrate modules depicting biological variables and processes for the other major subset of lipoprotein particles, i.e., high-density lipoprotein (HDL) particles. HDL particles are defined by the presence of one or more molecules of apoA per particle. Like apoB-100 particles, HDL particles are composed of varying ratios of TG, CE, FC, and PL, but are formed through the action of the plasma enzyme lecithin-cholesterol acetyltransferase (LCAT), which esterifies FC obtained from peripheral tissues into CE that is incorporated into nascent, or “lipid-poor” HDL. HDL particles are classified as lipid-poor (smallest), HDL-3, HDL-2, and HDL-1 (largest). The process of HDL formation is represented in the in FIG. 2. The model tracks the state variable CE/particle for HDL classes in a fashion similar to the apoB-100 particles. Equilibrium values for HDL particle compositions, catabolism rate, and number can be obtained by integrating reports from the literature.

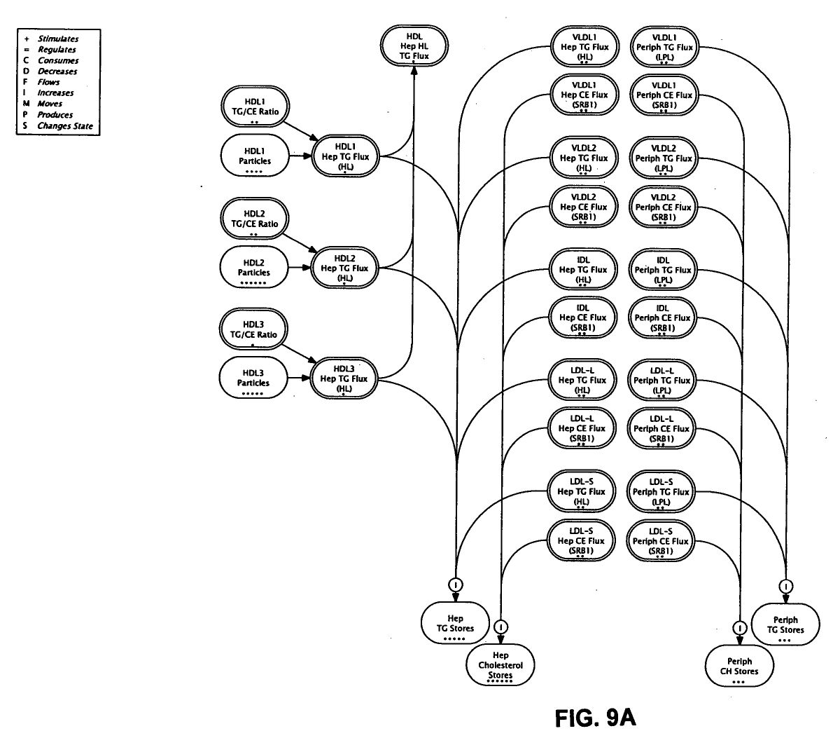

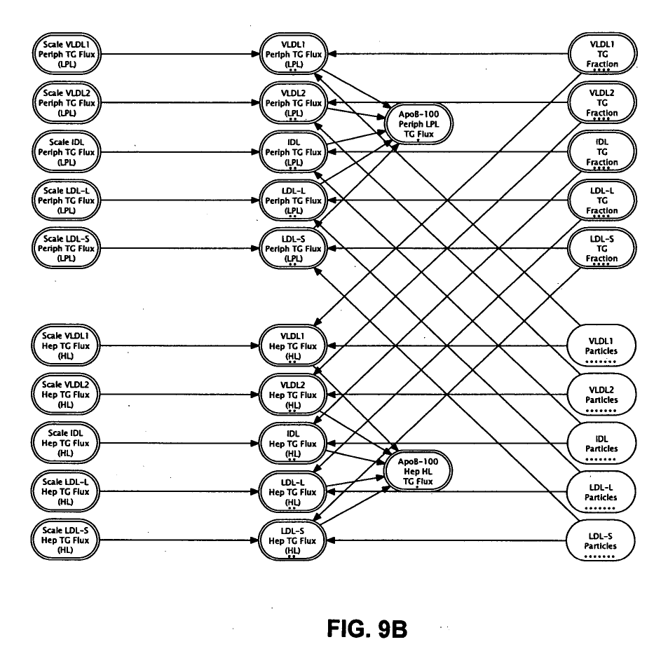

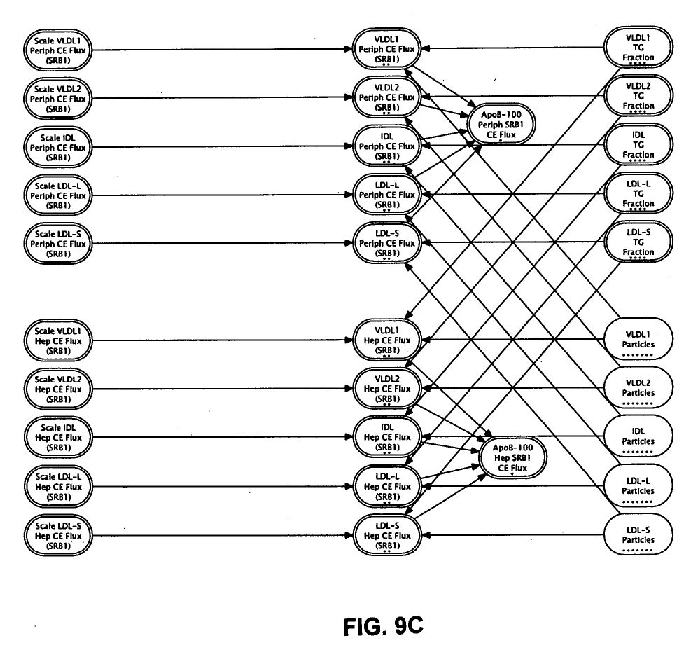

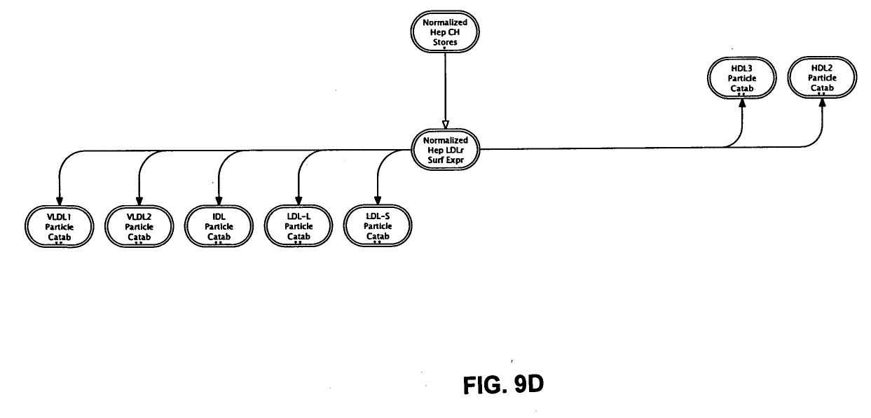

FIG. 6A illustrates biological processes and variables that affect lipid fluxes involved in hepatic feedback mechanisms. FIG. 6A illustrates feedback systems that regulate hepatic synthesis, secretion and catabolism of lipoprotein particles. In the embodiment illustrated in FIG. 6A, the lipid content of newly synthesized particles can be different than the average particle lipid content. Sensors of hepatic TG synthesis directly modulate apoB-100 particle synthesis rate and distribution between particle classes. Sensors of intrahepatic cholesterol stores modulate apoB-100 particle synthesis and apoB-100 and HDL particle catabolism by modulating the hepatic expression of LDL-receptor (LDL-R). The catabolism of particles via LDL-R in turn affects both the hepatic cholesterol synthesis (via HMG-CoA reductase), and triglyceride synthesis, completing the feedback loop (see, e.g., FIG. 9D).

FIG. 6B illustrates the independent regulation of peripheral cholesterol stores. Net peripheral cholesterol synthesis increases with decreasing peripheral cholesterol stores. Peripheral cholesterol stores are consumed by LCAT-mediate CE flux.

Effect Diagrams illustrating biological processes affected by peripheral and hepatic enzyme activity are illustrated in FIGS. 9A-9D. The module depicted in FIG. 9A provides an overview of the enzymes responsible for delipidation of apoB-100 and HDL particles. The module illustrated in FIG. 9B depicts the activity of lipoprotein lipase (LPL), which is expressed in peripheral tissues and hepatic lipase (HL), which is expressed in the liver. The module illustrated in FIG. 9C depicts the activity of scavenger receptor B-1 (SR-B1), which is expressed in peripheral tissues. The two modules taken together represent the action of LPL or HL to remove triglycerides, or SR-B1 to remove CE. Enzymatic action can be modulated by adjusting the value of Function Nodes (“Scale Periph TG Flux”, “Scale Hep TG Flux”, “Scale Hep CE Flux” and “Scale Periph CE Flux”). The net flux of TG or CE out of each particle class into the hepatic or peripheral stores (FIG. 9A) is summed for each particle class (FIGS. 9B-9C) and the peripheral or hepatic stores of TG and CE are adjusted accordingly.

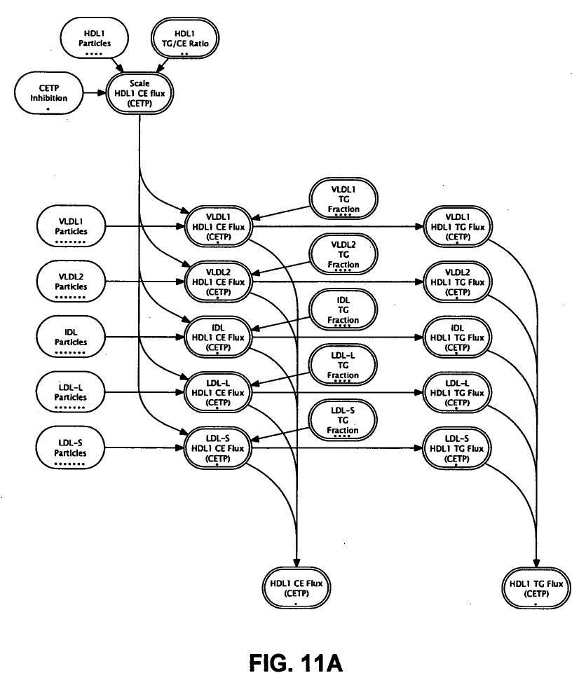

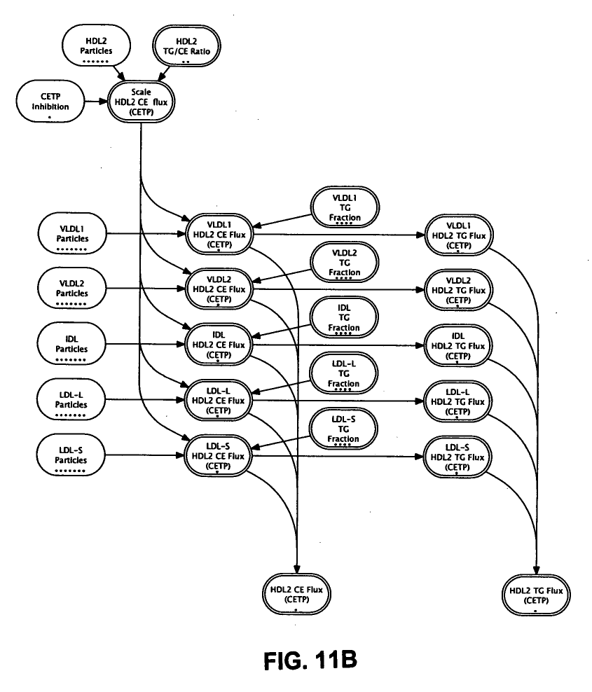

FIGS. 11A-11B depict modules that model the activity of cholesterol ester transfer protein (CETP). CETP is a plasma enzyme crucial for the “reverse cholesterol transport” from the periphery to the hepatic compartment. CETP facilitates the net exchange of CE in HDL particles for TG in apoB-100 particles. Hepatic catabolism of apoB-100 particles subsequently results in the removal of cholesterol from the bloodstream. In this embodiment, CETP is considered to remove CE only from HDL-1 and HDL-2 particles. A fixed molar exchange ratio is established for CETP-mediated exchange with each subclass of apoB-100 particle. Net fluxes of CE out of HDL and into apoB-100 particle class are determined, and a corresponding TG flux is calculated to achieve the specified molar exchange.

The module described in FIG. 13 depicts one method of modeling the processing of dietary cholesterol. In this embodiment, a fraction of the total amount of intestinal cholesterol is absorbed into the enterocytes; the remaining fraction is directly excreted. The absorbed cholesterol fraction is regulated by external factors, including dietary fiber or therapeutic interventions. Contributors to the total pool of intestinal cholesterol include (1) intracellular and membrane cholesterol in the enterocytes lost via cell shedding, and (2) dietary cholesterol sources. The absorbed intestinal cholesterol fraction contributes to the total intracellular enterocyte cholesterol pool. Cholesterol from this pool is transported to the hepatic compartment via chylomicra. In certain implementations, a time-averaged representation of chylomicron secretion by the enterocytes can be included rather than explicitly representating transient chylomicron dynamics in the post-prandial state. Cholesterol can be removed from the hepatic pool by (1) packaging and synthesis of lipoprotein particles, (2) conversion into bile and excreted via secretion into the intestinal tract, or (3) transport of unconverted cholesterol trapped in the bile into the intestinal tract.

The methods disclosed herein can be used to form computer model capable of simulating patient phenotypes and further can incorporate the addition of new components, as well as increased detail in components already modeled. For example, computer models predicting changes in the steady-state cholesterol balance in dyslipidemic patients with different genetic dysfunctions can be modeled. The genetic dysfunctions can be known genetic dysfunctions, such as a deficiency of cholesteryl ester transfer protein (see, e.g., Barter, et al., Arterioscler Thromb Vasc Biol, 23: 160-167, 2003). As will be appreciated by a person skilled in the art, newly discovered genetic defects in cholesterol metabolism can also be modeled using the methods described herein. Similarly, the computer models can incorporate biological features associated with lipoprotein particle classification, reclassification, synthesis, and catabolism.

In other embodiments, computer models of cholesterol metabolism are described herein. For example, computer models encoded in computer-readable media having computer-readable instructions stored thereon that, upon execution by a processor, cause the processor to simulate cholesterol metabolism, whether the instructions comprise a set of biological processes related to the lipoprotein particles and to lipid flux, and defining a set of mathematical relationships representing interactions among biological components of the biological processes are disclosed. At least two of the biological processes are represented by the mathematical relationships.

In other embodiments, computer models of cholesterol metabolism comprising a computer readable memory capable of storing codes and a processor coupled to the computer-readable memory, the processor configured to execute the codes. The memory comprises code to define a set of biological processes related biological processes associated with the lipoprotein particles and with the lipid flux, and code to define mathematical relationships representing interactions among biological components of the biological processes. At least two biological processes from the biological processes are associated with the mathematical relationships.

This invention can include a single computer model that serves a number of purposes. Alternatively, this layer can include a set of large-scale computer models covering a broad range of physiological systems. In addition to including a model of cholesterol metabolism, the system can include complementary computer models, such as, for example, epidemiological computer models and pathogen computer models. For use in healthcare, computer models can be designed to analyze a large number of subjects and therapies. In some instances, the computer models can be used to create a large number of validated virtual patients and to simulate their responses to a large number of therapies.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

E. Simulating Cholesterol Metabolism

The invention also provides methods of simulating cholesterol metabolism in an animal, said method comprises executing a computer model of cholesterol metabolism as described above. Methods of simulating cholesterol metabolism can further comprise applying a virtual protocol to the computer model to generate set of outputs represent a phenotype of the biological system. The phenotype can represent a normal state or a diseased state. In certain implementations, the methods can further include accepting user input specifying one or more parameters or variables associated with one or more mathematical representations prior to executing the computer model. Preferably, the user input comprises a definition of a virtual patient or a definition of the virtual protocol.

Running the computer model produces a set of outputs for a biological system represented by the computer model. The set of outputs represent one or more phenotypes of the biological system, i.e., the simulated subject, and includes values or other indicia associated with variables and parameters at a particular time and for a particular execution scenario. For example, a phenotype is represented by values at a particular time. The behavior of the variables is simulated by, for example, numerical or analytical integration of one or more mathematical relations to produce values for the variables at various times and hence the evolution of the phenotype over time.

The computer executable software code numerically solves the mathematical equations of the model(s) under various simulated experimental conditions. Furthermore, the computer executable software code can facilitate visualization and manipulation of the model equations and their associated parameters to simulate different patients subject to a variety of stimuli. See, e.g., U.S. Pat. No. 6,078,739, entitled “Managing objects and parameter values associated with the objects within a simulation model,” the disclosure of which is incorporated herein by reference. Thus, the computer model(s) can be used to rapidly test hypotheses and investigate potential drug targets or therapeutic strategies.

The level of detail reported to a user can vary depending on the level of sophistication of the target user. For a healthcare setting, especially for use by members of the public, it may be desirable to include a higher level of abstraction on top of a computer model. This higher level of abstraction can show, for example, major physiological subsystems and their interconnections, but need not report certain detailed elements of the computer model—at least not without the user explicitly deciding to view the detailed elements. This higher level of abstraction can provide a description of the virtual patient's phenotype and underlying physiological characteristics, but need not include certain parametric settings used to create that virtual patient in the computer model. When representing a therapy, this higher level of abstraction can describe what the therapy does but need not include certain parametric settings used to simulate that therapy in the computer model. A subset of outputs of the computer model that is particularly relevant for subjects and doctors can be made readily accessible.

In one implementation, the computer model is configured to allow visual representation of mathematical relations as well as interrelationships between variables, parameters, and biological processes. This visual representation includes multiple modules or functional areas that, when grouped together, represent a large complex model of a biological system.

In one implementation, the computer model can represent a normal state as well as an abnormal (e.g., a diseased or toxic) state of a biological system. For example, the computer model can begin with a representation of a normal phenotype as represented by the phenotype of a healthy normolipidemic animal. A normal phenotype can be modeled through a series of user-interface screens that define the elements, including biological variables and biological processes, of the phenotype being modeled. The computer model includes parameters that are altered to simulate an abnormal state or a progression towards the abnormal state. The parameter changes to represent a disease state are typically modifications of the underlying biological processes involved in a disease state, for example, to represent the genetic or environmental effects of the disease on the underlying physiology. By selecting and altering one or more parameters, a user modifies a normal state and induces a disease state of interest. In one implementation, selecting or altering one or more parameters is performed automatically. Examples of diseases of cholesterol metaoblism include genetic disorders, such as hypertriglyceridemia and hyperlipidemia, metabolic disorders such as non-insulin-dependent diabetes mellitus, metabolic syndrome, fatty liver, and medical conditions associated with an accumulation of one or more lipoprotein particles, such as atherosclerosis.

For example, in some embodiments, computer models can be formed that simulate cholesterol metabolism in a healthy individual by generating a virtual patient blood cholesterol profile. The profile can include the number and classes of apoB-100 particles, the number and classes of HDL particles and total plasma cholesterol and triglycerides. Changes can be made to one or more of the variables comprising the model, e.g., the addition of dietary cholesterol, and the effect of the change can be predicted by generating a new virtual patient blood cholesterol profile.

One or more virtual patients in conjunction with the computer model can be created based on an initial virtual patient that is associated with initial parameter values. A different virtual patient can be created based on the initial virtual patient by introducing a modification to the initial virtual patient. Such modification can include, for example, a parametric change (e.g., altering or specifying one or more initial parameter values), altering or specifying behavior of one or more variables, altering or specifying one or more functions representing interactions among variables, or a combination thereof. For instance, once the initial virtual patient is defined, other virtual patients may be created based on the initial virtual patient by starting with the initial parameter values and altering one or more of the initial parameter values. Alternative parameter values can be defined as, for example, disclosed in U.S. Pat. No. 6,078,739. These alternative parameter values can be grouped into different sets of parameter values that can be used to define different virtual patients of the computer model. For certain applications, the initial virtual patient itself can be created based on another virtual patient (e.g., a different initial virtual patient) in a manner as discussed above.

Alternatively, or in conjunction, one or more virtual patients in the computer model can be created based on an initial virtual patient using linked simulation operations as, for example, disclosed in the following publication: “Method and Apparatus for Conducting Linked Simulation Operations Utilizing A Computer-Based System Model”, (U.S. Application Publication No. 20010032068, published on Oct. 18, 2001). This publication discloses a method for performing additional simulation operations based on an initial simulation operation where, for example, a modification to the initial simulation operation at one or more times is introduced. In the present embodiment of the invention, such additional simulation operations can be used to create additional virtual patients in the computer model based on an initial virtual patient that is created using the initial simulation operation. In particular, a virtual patient can be customized to represent a particular subject. If desired, one or more simulation operations may be performed for a time sufficient to create one or more “stable” virtual patient of the computer model. Typically, a “stable” virtual patient is characterized by one or more variables under or substantially approaching equilibrium or steady-state condition.

Various virtual patients of the computer model can represent variations of the biological system that are sufficiently different to evaluate the effect of such variations on how the biological system responds to a given therapy. In particular, one or more biological processes represented by the computer model can be identified as playing a role in modulating biological response to the therapy, and various virtual patients can be defined to represent different modifications of the one or more biological processes. The identification of the one or more biological processes can be based on, for example, experimental or clinical data, scientific literature, results of a computer model, or a combination of them. Once the one or more biological processes at issue have been identified, various virtual patients can be created by defining different modifications to one or more mathematical relations included in the computer model, which one or more mathematical relations represent the one or more biological processes. A modification to a mathematical relation can include, for example, a parametric change (e.g., altering or specifying one or more parameter values associated with the mathematical relation), altering or specifying behavior of one or more variables associated with the mathematical relation, altering or specifying one or more functions associated with the mathematical relation, or a combination of them. The computer model may be run based on a particular modification for a time sufficient to create a “stable” configuration of the computer model.

In certain implementations, the model of cholesterol metabolism is executed while applying a virtual stimulus or protocol representing, e.g., altered eating patterns or administration of a drug. A virtual stimulus can be associated with a stimulus or perturbation that can be applied to a biological system. Different virtual stimuli can be associated with stimuli that differ in some manner from one another. Stimuli that can be applied to a biological system can include, for example, existing or hypothesized therapeutic agents, treatment regimens, and medical tests. Additional examples of stimuli include exposure to existing or hypothesized disease precursors. Further examples of stimuli include environmental changes such as those relating to changes in level of exposure to an environmental agent (e.g., an antigen), and changes in level of physical activity or exercise.

A virtual protocol, e.g., a virtual therapy, representing an actual therapy can be applied to a virtual patient in an attempt to predict how a real-world equivalent of the virtual patient would respond to the therapy. Virtual protocols that can be applied to a biological system can include, for example, existing or hypothesized therapeutic agents and treatment regimens, mere passage of time, exposure to environmental toxins, increased exercise and the like. By applying a virtual protocol to a virtual patient, a set of results of the virtual protocol can be produced, which can be indicative of various effects of a therapy.

For certain applications, a virtual protocol can be created, for example, by defining a modification to one or more mathematical relations included in a model, which one or more mathematical relations can represent one or more biological processes affected by a condition or effect associated with the virtual protocol. A virtual protocol can define a modification that is to be introduced statically, dynamically, or a combination thereof, depending on the particular conditions and/or effects associated with the virtual protocol.

In some embodiments, computer models are formed that can simulate the action of therapeutic agents on the number and lipid content of lipoprotein particles implicated in various disease states associated with a genetic or metabolic defect in cholesterol metabolism. IDL have been linked to an increased risk of heart disease (see, e.g., Packard and Shepherd, 1997, supra). LDL particles are the major cholesterol carrying lipoproteins in plasma and are strongly implicated in atherogenesis. Moreover, the size and heterogeneity of LDL particles can be used as a predictor of heart disease. For example, in normal and hyperlipidemic subjects, discrete fractions of LDL are present, for example, LDL-I, LDL-II, LDL-III, and LDL-IV, with the smaller fractions predominating in hyperlipidemic subjects. Additionally, a link between LDL size and triglyceride content has been observed. Large LDL's, i.e., LDL-I, is associated with low plasma triglyceride levels, whereas small LDL's, i.e., LDL-IV is associated with high plasma triglyceride levels (see, e.g., Packard and Shepherd, 1997, supra, and references cited within).

The modules depicted in FIGS. 6A-6B, can be used to model the effects of HMG-CoA reductase inhibition and ezetimibe on the regulation of cholesterol synthesis and excretion (Function Nodes “HMG-CoA Reductase” and “Ezetimibe Therapy”). HMG-CoA reductase inhibitors are specified to reduce the Function Node “Hepatic Cholesterol Synthesis”. Dietary cholesterol input and excretion is modeled as a zeroth order process; a fixed percentage of dietary cholesterol is moved into the hepatic cholesterol stores. Excretion of cholesterol is constitutive, but can be modulated to increase or decrease excretion.

Similarly, the modules depicted in FIGS. 11a-11B can be used to model the effect of therapeutic agents on the activity of CETP. In this embodiment, CETP inhibition therapy directly inhibits the CE flux out of HDL particles. The TG flux exchanged for CE is automatically reduced as a consequence.

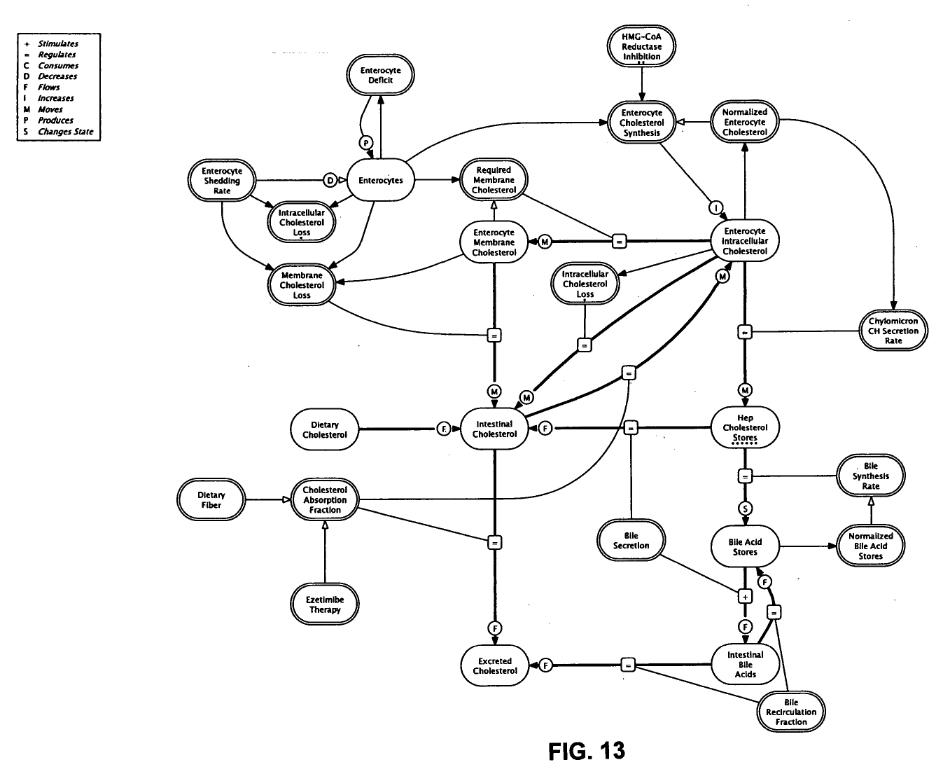

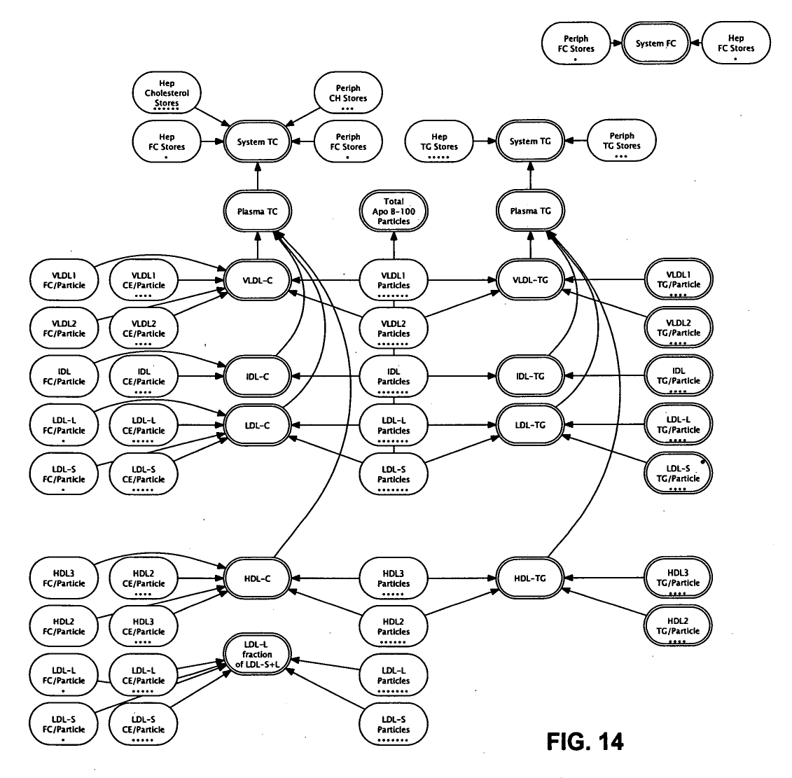

Data for the various Effect and Summary Diagrams and modules illustrated in FIGS. 2-13 can be obtained from laboratory tests of blood of human patients undergoing blood cholesterol screening. Such tests typically provide measurements of total triglyceride (Total TG), cholesterol (Plasma TC), LDL cholesterol (LDL-C), and HDL cholesterol (HDL-C). The Effect Diagram in FIG. 14 calculates these values in specific Function Nodes in real time for the model's virtual patients. The model furthermore provides additional values that may have clinical significance, including IDL- and VLDL-cholesterol (IDL-C and VLDL-C), and the breakdown of total triglycerides into each particle class (VLDL-TG, IDL-TG, LDL-TG, HDL-TG). In addition, a Function Node calculates the fraction of total LDL particles that are LDL-L and LDL-S, along with the total system cholesterol (System TC) and system triglycerides (System TG).

It is to be understood that both the foregoing general description and the following detailed description are exemplary and explanatory only and are not restrictive of the methods and models described herein. In this application, the use of the singular includes the plural unless specifically stated otherwise. Also the use of “or” means “and/or” unless stated otherwise. Similarly, “comprise, “comprises,” “comprising,” “include,” includes,” and “including,” are not intended to be limiting.

### IV. EXAMPLES

A. Method for Developing a Computer Model for Cholesterol Metabolism Based Particle Number and Lipid Content

The key equations that define the models described herein are those that calculate the net CE flux and net TG flux for each lipoprotein particle class. The net CE and TG fluxes can then be used to determine the dynamic changes in lipoprotein particle composition and particle number that can occur within each size class. An explanation of the variables used in the equations is shown below:

Indices and Subscripts

Index i covers ApoB-100 particles (5 classes): VLDL-1, VLDL-2, IDL, LDL-L, and LDL-S (index increases with decreasing particle size)

Index j covers HDL particles (2 classes): HDL1, HDL2 (index increases with decreasing particle size)

CE: Cholesterol Ester

TG: Triglycerides

Variables

Nᵢ: number of particles in class i
SAᵢ: Surface area of particle in class i
CEᵢ: average CE content of particle in class i
CEᵢ^{syn}: CE content of newly synthesized particle in class i

TGᵢ: average TG content of particle in class i

Rᵢ: CETP exchange molar ratio for class i

C. Scalars

synᵢ: synthesis rate for particles of class i

catabᵢ: catabolism rate for particles of class i

Vᵢ: specified volume for particles of class i

d_{CE}: density of CE

d_{TG}: density of TG

M_{CE}: molar mass of CE

M_{TG}: molar mass of TG

A: Scalar for hepatic flux from particle class i

B: Scalar for peripheral flux from particle class i

C: Scalar for CETP-mediated flux from particle class i to particle class j

W1-W10: Weighting exponent

1. Calculation of Net CE Flux and Net TG Flux Based on Enzymatic and Receptor-Mediated Actions for Each Particle Class

An example of the flux equations for ApoB-100 particles are shown below:

Hepatic CE Flux via SR-B 1 per particle class i
(Hᵢ^{CE})=Aᵢ^{CE}*nᵢ*(SAᵢ^{W1}*CEᵢ^{W2})

Peripheral CE Flux via SR-B1 per particle class i
(Pᵢ^{CE})=Bᵢ^{CE}*nᵢ*(SAᵢ^{W3}*CEᵢ^{W4})

CE Flux from particle class i to j via CETP
(Fᵢⱼ^{CE})=Cᵢⱼ^{CE}*TGᵢ^{W5}*(nᵢ*SAᵢ)^{W6}

CE Flux from particle class i to j via CETP

$$( {F}_{ij}^{TG} ) = \frac{{F}_{ij}^{CE}}{{R}_{i} * \frac{{M}^{CE}}{{M}^{TG}}}$$

Hepatic TG Flux via HL per particle class i
(Hᵢ^{TG})=Aᵢ^{TG}*nᵢ*(SAᵢ^{W7}*TGᵢ^{W8})

Peripheral TG Flux via LPL per particle class i
(Pᵢ^{TG})=Aᵢ^{TG}*nᵢ*(SAᵢ^{W9}*TGᵢ^{W10})

Net CE Flux per particle class i
Fₙₑₜ_{ᵢ}^{CE}=−Hᵢ^{CE}−Pᵢ^{CE}+ΣⱼFᵢⱼ^{CE}

Net TG Flux per particle class i
Fₙₑₜ_{ᵢ}^{TG}=−Hᵢ^{TG}−Pᵢ^{TG}−ΣⱼFᵢⱼ^{TG}

Flux equations for HDL particles are not provided, because they are similar to the equations used for the ApoB-100 particles.

2. Calculation of Remodeling and Reclassification Terms for Each Particle Class Based on the Fluxes and Constraints of Each Particle Class Being Defined as Constant Volume

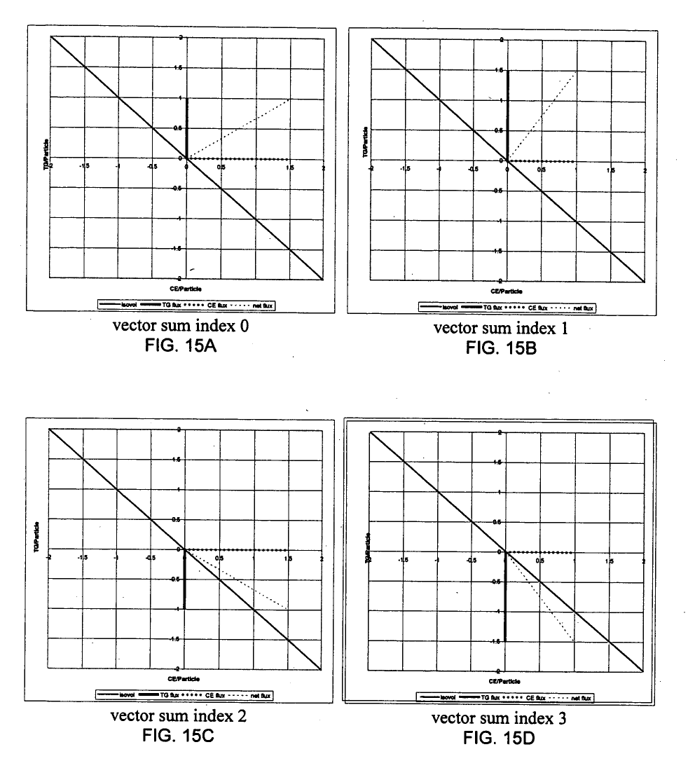

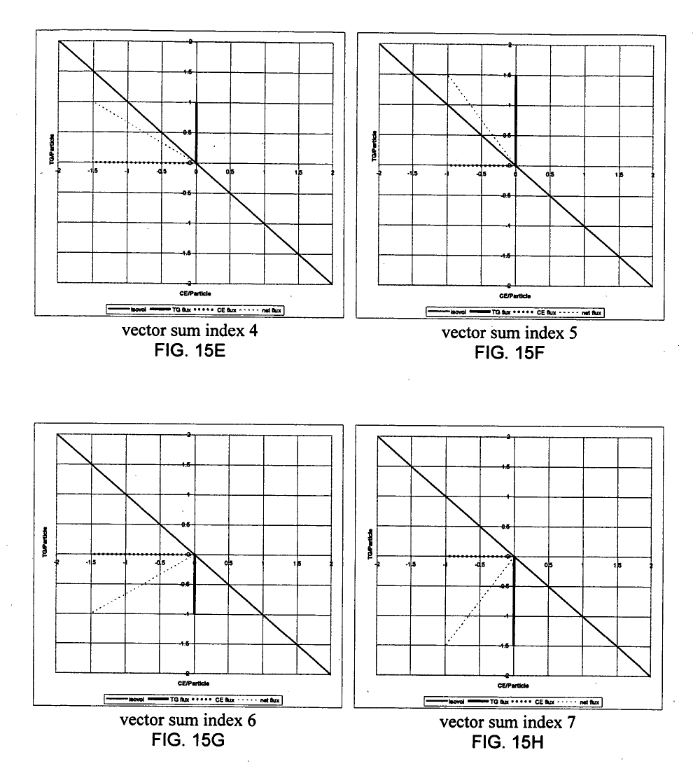

As depicted in FIG. 1D and FIGS. 15A-F, the net CE flux and net TG flux can be combined in a vector sum to determine the net effect of the underlying enzymatic and receptor-mediated actions on each particle class. Since each particle class is defined by physical size, the composition of a particle class is constrained to lie along an iso-volume contour depicted within TG-CE space as a diagonal line whose slope is determined by the relative densities of TG and CE. In the diagram shown, the vector sum of the two net fluxes leads to two distinct terms: a remodeling term which is along the iso-volume contour (in this case, increased CE and decreased TG for a net movement of right and down), with a reclassification term (in this case, negative TG flux for a reclassification of particles from this particle class to a smaller particle class along an iso-CE contour).

FIG. 1D depicts only one of 8 possible configurations of the vector sum of the net TG and CE fluxes. Table 1 below lists all possible configurations of the vector sum resulting from different signs and relative magnitudes of the fluxes:

TABLE 1

| vector sum index | Fₙₑₜ_{ᵢ}^{CE} | Fₙₑₜ_{ᵢ}^{TG} | $\frac{\vert {F}_{{net}_{i}}^{CE} \vert}{{d}_{CE}} - \frac{\vert {F}_{{net}_{i}}^{TE} \vert}{{d}_{TG}}$ | condition | reclass direction |
|---|---|---|---|---|---|
| 0 | + | + | + | diag | up |
| 1 | + | + | − | diag | up |
| 2 | + | − | + | isoTG | up |
| 3 | + | − | − | isoCE | down |
| 4 | − | + | + | isoTG | down |
| 5 | − | + | − | isoCE | up |
| 6 | − | − | + | diag | down |
| 7 | − | − | − | diag | down |

FIG. 1D is an example of vector sum index three. Vector diagrams for all eight vector sum indices are shown in FIGS. 15A-15H.

Each of the eight vector sum indices in Table 1 results in a different set of conditions that define the equations for the four terms needed to calculate the dynamics of particle reclassification and remodeling. Descriptions of the three conditions that define the equations are shown below:

isoTG: reclassification results from an excess of net CE flux relative to the net TG flux for the iso-volume constraint. As a result, the particle is reclassified in smaller or larger class with the same TG content as the original particle.

isoCE: reclassification results from an excess of net TG flux relative to the net CE flux for the iso-volume constraint. As a result, the particle is reclassified in smaller or larger class with the same CE content as the original particle.

diag: reclassification results from either both net fluxes being positive (particle reclassified in larger class) or both net fluxes being negative (particle reclassified in smaller class).

Definitions for the terms used in the equations are as follows:

reclassᵢ^{down} rate at which particles are reclassified into a smaller particle class

reclassᵢ^{up} rate at which particles are reclassified into a larger particle class

CEᵢ^{reclass} CE composition of particles upon reclassification

remodelᵢ rate of change of average CE content for a particle class

Equations for the terms and conditions resulting from the vector sum indices are shown below in Table 2.

TABLE 2

| | Condition | | |
|---|---|---|---|
| Term | isoCE | isoTG | diag |
| ${reclass}_{i}^{down}$ | $\frac{\frac{\vert {F}_{{net}_{i}}^{TG} \vert}{{d}_{TG}} - \frac{\vert {F}_{{net}_{i}}^{C E} \vert}{{d}_{CE}}}{{V}_{i} - {V}_{i + 1}}$ | $\frac{\frac{\vert {F}_{{net}_{i}}^{CE} \vert}{{d}_{CE}} - \frac{\vert {F}_{{net}_{i}}^{TG} \vert}{{d}_{TG}}}{{V}_{i} - {V}_{i + 1}}$ | $\frac{- ( \frac{{F}_{{net}_{i}}^{CE}}{{d}_{CE}} + \frac{{F}_{{net}_{i}}^{TG}}{{d}_{TG}} )}{{V}_{i} - {V}_{i + 1}}$ |
| ${reclass}_{i}^{up}$ | $\frac{\frac{\vert {F}_{{net}_{i}}^{TG} \vert}{{d}_{TG}} - \frac{\vert {F}_{{net}_{i}}^{C E} \vert}{{d}_{CE}}}{{V}_{i - 1} - {V}_{i}}$ | $\frac{\frac{\vert {F}_{{net}_{i}}^{CE} \vert}{{d}_{CE}} - \frac{\vert {F}_{{net}_{i}}^{TG} \vert}{{d}_{TG}}}{{V}_{i - 1} - {V}_{i}}$ | $\frac{\frac{{F}_{{net}_{i}}^{CE}}{{d}_{CE}} + \frac{{F}_{{net}_{i}}^{TG}}{{d}_{TG}}}{{V}_{i - 1} - {V}_{i}}$ |
| ${CE}_{i}^{reclass}$ | CEᵢ | $\begin{matrix}for reclass down \text{:} \\ {d}_{CE} ( {V}_{i - 1} - \frac{{TG}_{i}}{{d}_{TG}} )\end{matrix}$ $\begin{matrix}for reclass \text{up} \text{:} \\ {d}_{CE} ( {V}_{i - 1} - \frac{{TG}_{i}}{{d}_{TG}} )\end{matrix}$ | $\begin{matrix}for reclass down \text{:} \\ {CE}_{i} - \frac{{F}_{{net}_{i}}^{CE} {d}_{CE} {d}_{TG} ( {V}_{i} - {V}_{i + 1} )}{{F}_{{net}_{i}}^{CE} {d}_{TG} + {F}_{{net}_{i}}^{TG} {d}_{CE}}\end{matrix}$ $\begin{matrix}for reclass up \text{:} \\ {CE}_{i} + \frac{{F}_{{net}_{i}}^{CE} {d}_{CE} {d}_{TG} ( {V}_{i - 1} - {V}_{i} )}{{F}_{{net}_{i}}^{CE} {d}_{TG} + {F}_{{net}_{i}}^{TG} {d}_{CE}}\end{matrix}$ |
| remodelᵢ | $\frac{{F}_{{net}_{i}}^{CE}}{{N}_{i}}$ | $\frac{- {d}_{CE} ( \frac{{F}_{{net}_{i}}^{TG}}{{d}_{TG}} )}{{N}_{i}}$ | 0 |

3. Calculation of Final Remodeling (CE/Particle) and Reclassification (Number of Particles Per Class) Rates

The equations for shown in Table 2 can be combined to provide a final equation that calculates the reclassification rate:

$$\frac{ⅆ {N}_{i}}{ⅆ t} = {syn}_{i} - {catab}_{i} + {reclass}_{i - 1}^{down} + {reclass}_{i + 1}^{up} - {reclass}_{i}^{down} - {reclass}_{i}^{up}$$

and a final equation that calculates the remodeling rate:

$$\frac{ⅆ {CE}_{i}}{ⅆ t} = \frac{{syn}_{i} ( {CE}_{i}^{syn} - {CE}_{i} )}{{N}_{i}} + \frac{{reclass}_{i - 1}^{down} ( {CE}_{i - 1}^{reclass} - {CE}_{i} )}{{N}_{i}} + \frac{{reclass}_{i + 1}^{up} ( {CE}_{i + 1}^{reclass} - {CE}_{i} )}{{N}_{i}} + {remodel}_{i}$$

B. Computer Simulated Lipoprotein Profiles of Virtual Patients Treated with HMG-CoA Reductase Inhibition Therapy

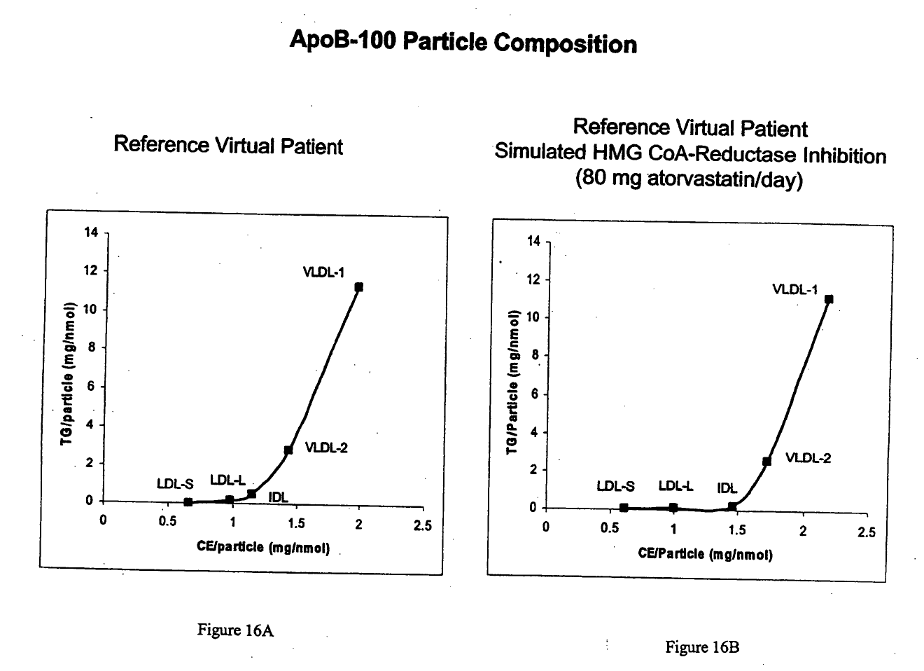

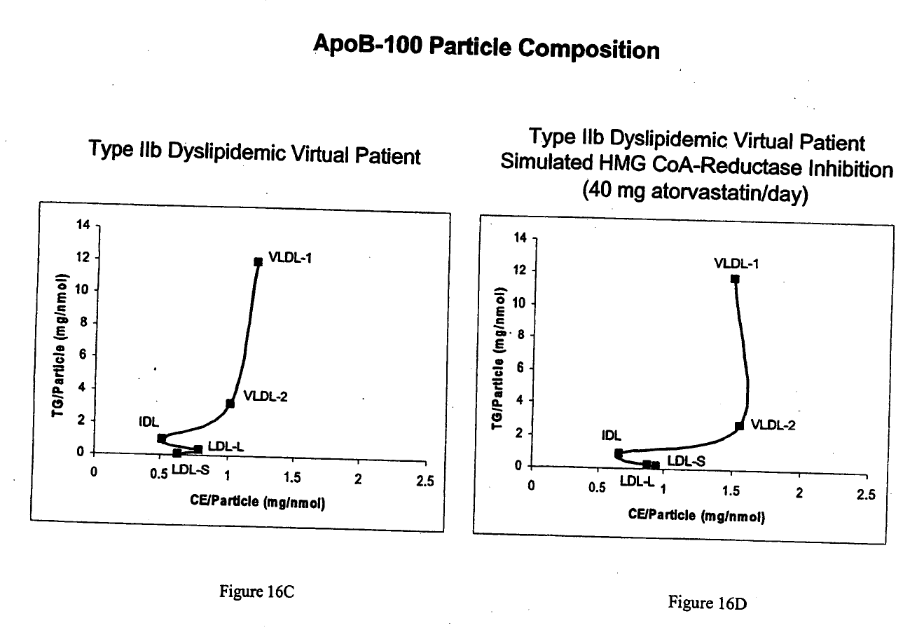

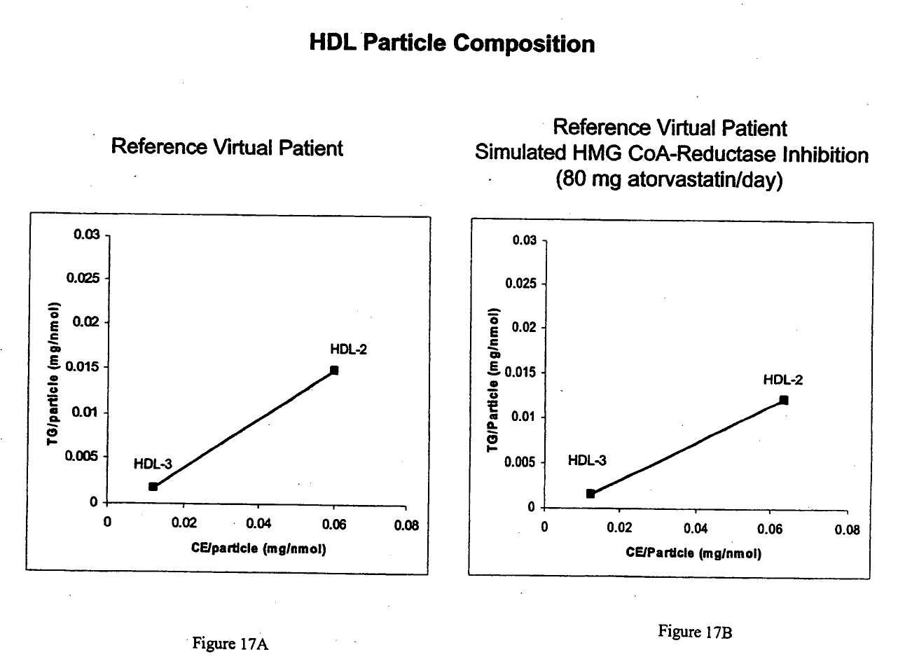

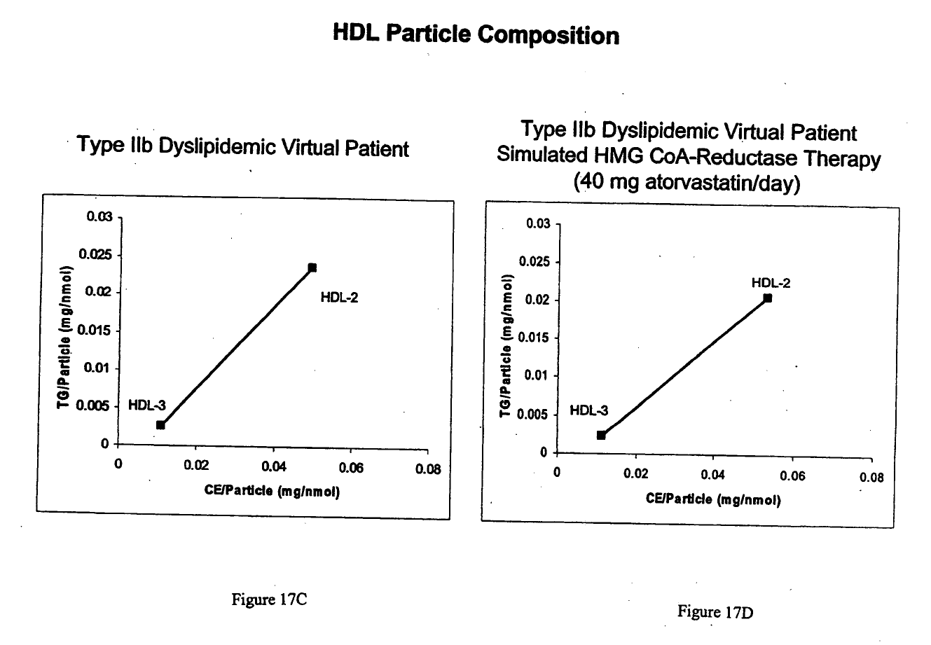

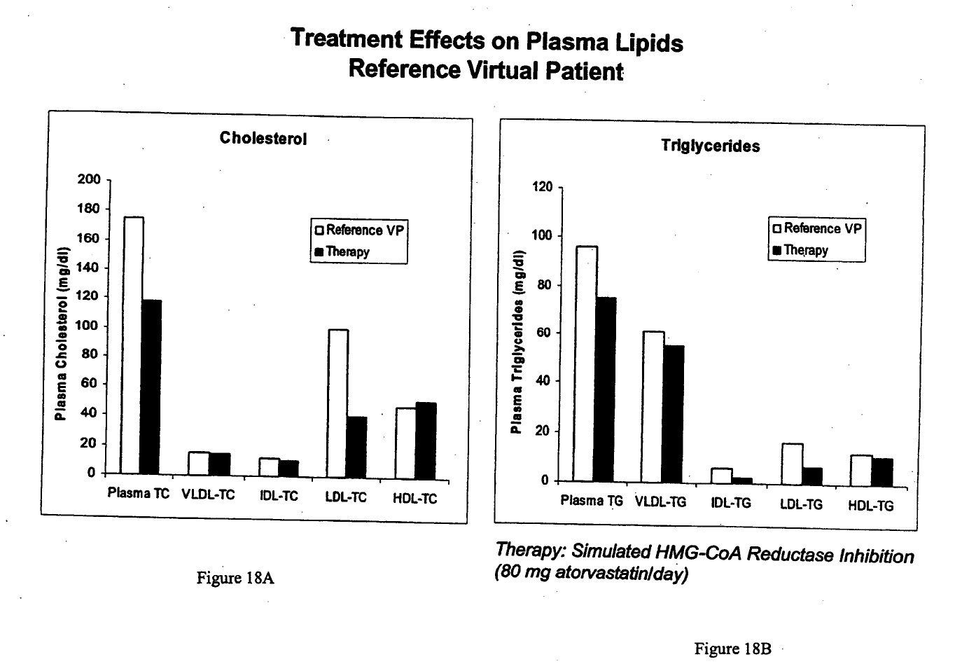

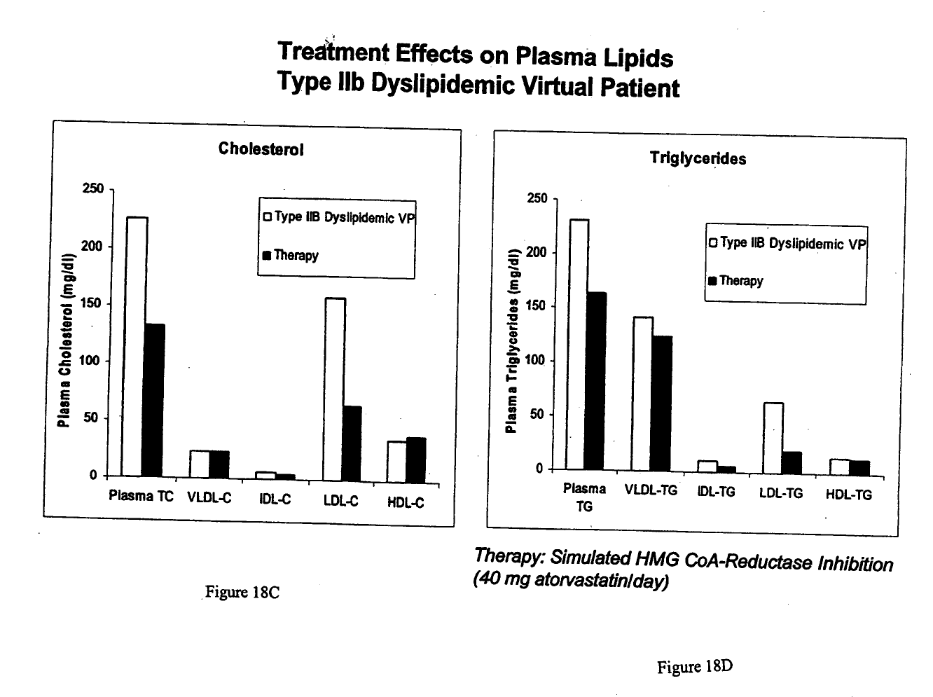

As shown in FIG. 2, the CE and TG content of each particle class can be computed and plotted at each time point during a simulation to provide real-time insight into the change of a virtual patient's lipoprotein profile during a treatment regimen. A reference virtual patient's baseline (equilibrium) lipoprotein profile and that exhibited after a typical HMG-CoA Reductase inhibition therapy are shown in FIGS. 16A-16B and 17A-17B. FIGS. 18A and 18B depict the reference virtual patient's baseline plasma lipid profile and that exhibited after a typical HMG-CoA Reductase inhibition therapy.

The direct effect of a typical atorvastatin (HMG CoA reductase inhibition) therapy on the Reference Virtual Patient is a reduction in hepatic cholesterol stores. Two independent feedback loops respond to this reduction, resulting in: 1) a decrease in the number of apoB-100 particles synthesized (see FIG. 6A); and 2) an increase in hepatic catabolism of apoB-100 particles due to upregulation of LDL-R (see FIG. 9D). The combination of these two responses causes both a net reduction in the total number of apoB-100 particles circulating in the plasma and a concomitant reduction in plasma total cholesterol (FIG. 18A). The simulation predicts that the LDL classes exhibit the most significant reduction in particle number; hence, LDL-C is also greatly reduced (FIG. 18A). No feedback response to the simulated therapy significantly affects steady-state apoB-100 TG/particle; hence, the reduction in total apoB-100 particle number reduces total plasma TG as well (FIG. 18B). The therapy-induced changes to apoB-100 particle synthesis also result in modified apoB-100 and HDL particle compositions. For example, the simulated therapy causes a shift of the lipoprotein TG/CE content curve to the right, reflecting increases in steady-state average CE/particle for the LDL-L, IDL, VLDL-2, and VLDL-1 particle classes post-treatment (FIGS. 16A-B). This behavior can be explained by a reduced contribution of newly-synthesized particles, which contain low CE/particle, to the new equilibrium condition under therapy (see vector math equations). Furthermore, fewer plasma apoB-100 particles necessitate a reduction in CETP-mediated TG flux from apoB-100 particles into HDL-2 particles. This is reflected in the reduced TG/particle observed in HDL-2 after simulated therapy (FIGS. 17A-B).

Similarly, the baseline lipoprotein profile and plasma lipid profile can be modeled for a type IIb dyslipidemic virtual patient. The type IIb dyslipidemic virtual patient baseline (equilibrium) lipoprotein profile and that exhibited after a typical HMG-CoA Reductase inhibition therapy are shown in FIGS. 16C-16D and 17C-17D. FIGS. 18C and 18D depict the type IIb dyslipidemic virtual patient baseline plasma lipid profile and that exhibited after a typical HMG-CoA Reductase inhibition therapy.

The qualitative response of the Type IIb Dyslipidemic Virtual Patient to simulated 40 mg/day atorvastatin therapy is similar to that observed for the Reference Virtual Patient on atorvastatin. ApoB-100 particles increase in steady-state average CE/particle, resulting in a shift of the TG/CE content curve to the right (FIGS. 16C-D). HDL-2 particles exhibit a reduction in TG/particle (FIGS. 17C-D). Finally, plasma TC, LDL-C, plasma TG, and LDL-TG are markedly reduced as a result of the mechanisms discussed above.

What is claimed is:

1. A method for developing a computer model of cholesterol metabolism in an animal, said method comprising:
identifying one or more biological processes associated with lipoprotein particles;
identifying one or more biological processes associated with lipid flux;
mathematically representing each biological process to generate one or more representations of a biological process associated with lipoprotein particles and one or more representations of a biological process associated with lipid flux; and
combining the representations of biological process to form a computer model of the cholesterol metabolism.

2. The method of claim 1, wherein one or more of the biological process associated with lipid flux is a biological process comprising one or more of lipid flux from liver tissue to a lipoprotein particle, lipid flux from a lipoprotein particle to liver tissue, lipid flux from one lipoprotein particle to another lipoprotein particle of the same or different class or subclass, lipid flux from peripheral tissue to a lipoprotein particle, or lipid flux from a lipoprotein particle to a peripheral tissue.

3. The method of claim 1, wherein the representation of a biological process associated with lipid flux comprises one or more of a variable representing total cholesterol, total triglyceride, a cholesterol ester (CE) per particle class and/or subclass, a triglyceride (TG) content per particle class and/or subclass, a hepatic enzyme, a peripheral enzyme, a hepatic receptor, a peripheral receptor, or a therapeutic agent.

4. The method of claim 1, wherein the biological process associated with lipoprotein particles is a biological process associated with synthesis, reclassification or catabolism of lipoprotein particles.

5. The method of claim 1, wherein the representation of a biological process associated with lipoprotein particles comprises one or more of a variable representing a class of lipoprotein particles, a subclass of lipoprotein particles, a number of lipoprotein particles, an apolipoprotein composition of a lipoprotein particle, a cholesteryl ester (CE) content of a lipoprotein particle, a triglyceride (TG) content of a lipoprotein particle, a free cholesterol (FC) content of a lipoprotein particle, a hepatic enzyme, a hepatic receptor, or a therapeutic agent.

6. The method of claim 1, wherein one or more of the biological processes is associated with lipoprotein particle secretion from a hepatic compartment.

7. The method of claim 1, wherein mathematically representing a biological processes comprises:
forming a first mathematical relation among variables associated with a first biological process from one or more of the biological processes associated with lipoprotein particles and/or lipid flux; and
forming a second mathematical relation among variables associated with the first biological process and a second biological process from one or more of the biological processes associated with lipoprotein particles and/or lipid flux.

8. The method of claim 7, further comprising:
creating a set of parametric changes in the first mathematical relation and the second mathematical relation; and
producing a simulated biological attribute based on at least one parametric change from the set of parametric changes, the simulated biological attribute being substantially consistent with at least one biological attribute associated with a reference pattern of a first cholesterol metabolic steady state.

9. The method of claim 8, further comprising:
a) converting a parameter into a converted biological variable, the value of which changes upon perturbation of cholesterol homeostasis in an animal, the parameter being associated with at least one from the first mathematical relation and the second mathematical relation; and,
b) producing a series of simulated biological attributes based on the converted biological variable, the series of simulated biological attributes being substantially consistent with a corresponding biological attribute associated with a reference pattern of an animal, the series of simulated biological attributes representing a second cholesterol metabolic steady state.

10. A computer-readable medium having computer-readable instructions stored thereon that, upon execution by a processor, cause the processor to simulate cholesterol metabolism in an animal, and further wherein the instructions comprise:
a) defining a mathematical representation of one or more biological processes associated with lipoprotein particles;
b) defining a mathematical representation of one or more biological processes associated with lipid flux; and
c) defining a set of mathematical relationships between the representations of biological processes to form a model of cholesterol metabolism.

11. The computer-readable medium of claim 10, wherein the instructions further comprise accepting user input specifying one or more parameters or associated with one or more of the mathematical representations.

12. The computer-readable medium of claim 10, wherein the instructions further comprise applying a virtual protocol to the model of cholesterol metabolism.

13. The computer-readable medium of claim 12, wherein the virtual protocol represents a therapeutic regimen, a diagnostic procedure, passage of time, or an altered diet.

14. The computer-readable medium of claim 10, wherein the instructions further comprise defining one or more virtual patients.

15. A method of simulating cholesterol metabolism in an animal, said method comprising executing a computer model according to claim 10

16. The method of claim 15, further comprising applying a virtual protocol to the computer model to generate a set of outputs representing a phenotype of a biological system.

17. The method of claim 16, wherein the virtual protocol comprises a therapeutic regimen, a diagnostic procedure, passage of time, or an altered diet.

18. The method of claim 16, wherein the phenotype represents a diseased state.

19. The method of claim 15, further comprising accepting user input specifying one or more parameters or variable associated with one or more mathematical representations prior to executing the computer model.

20. A system comprising:
a) a processor including computer-readable instructions stored thereon that, upon execution by a processor, cause the processor to simulate cholesterol metabolism in an animal, the computer readable instructions comprising:
i) mathematically representing one or more biological processes associated with lipoprotein particles;
ii) mathematically representing one or more biological processes associated with lipid flux; and
iii) defining a set of mathematical relationships between the representations of biological processes associated with lipoprotein particles and representations of biological processes associated lipid flux;
iv) applying a virtual protocol to the set of mathematical relationships to generate a set of outputs;
b) a first user terminal, the first user terminal operable to receive a user input specifying one or more parameters associated with one or more mathematical representations defined by the computer readable instructions; and
c) a second user terminal, the second user terminal operable to provide the set of outputs to a second user.
